(19) United States
(12) Patent Application Publication
(10) Pub. No.: US 2017/0334734 A1
(43) Pub. Date: Nov. 23, 2017

(54) COMPOSITION FOR PRODUCING ZINC OXIDE THIN FILM CONTAINING GROUP 2 ELEMENT AND METHOD FOR PRODUCING SAME

(71) Applicant: Tosoh Finechem Corporation, Shunan-shi, Yamaguchi (JP)

(72) Inventors: Kenichi HAGA, Shunan-shi, Yamaguchi (JP); Kouji TOYOTA, Shunan-shi, Yamaguchi (JP); Shizuo TOMIYASU, Shunan-shi, Yamaguchi (JP); Koichiro INABA, Shunan-shi, Yamaguchi (JP)

(21) Appl. No.: 15/520,931

(22) PCT Filed: Oct. 1, 2015
(86) PCT No.: PCT/JP2015/077899

§ 371 Date: Apr. 21, 2017

(30) Foreign Application Priority Data
Oct. 24, 2014 (JP) 2014-217558

(51) Int. Cl. C01G 9/02; C07F 3/06; C07F 3/02; C07F 5/06

(52) U.S. Cl. CPC C01G 9/02; C07F 5/06; C07F 3/06; C07F 3/02; C01P 2006/60; C01P 2002/72

(57) ABSTRACT

The present invention relates to a composition for producing a zinc oxide thin film containing a group 2 element, said composition being a solution in which a partial hydrolysate of an organic zinc compound represented by formula (1) and a group 2 element are dissolved in an organic solvent. The solution can additionally include a group 13 element. Formula (1): R1-Zn-R1 (in the formula, R1 is a straight-chain or branched alkyl group having 1-7 carbon atoms). Provided are: a composition for producing a zinc oxide thin film containing a group 2 element, said composition making it possible to form a zinc oxide thin film containing a group 2 element by performing coating and film formation with one solution; and a production method for the composition.

### TECHNICAL FIELD

The present invention relates to a composition for producing a zinc oxide thin film containing a group 2 element which allows formation of a zinc oxide thin film containing a group 2 element by heating, is prepared from an organic zinc compound as a starting material, has no ignitability and is easy to handle, and to a method for producing the composition.

### CROSS-REFERENCE TO RELATED APPLICATIONS

The present application claims priority to Japanese Patent Application No. 2014-217558 filed on 24 Oct. 2014, which is entirely incorporated herein by reference.

### BACKGROUND ART

A zinc oxide thin film containing a group 2 element typically including magnesium (Mg) which has high transparency of visible light has wide applications such as zinc oxide photocatalytic membranes, ultraviolet protecting membranes, infrared reflecting membranes and antistatic membranes because of a wide bandgap due to formation of mixed crystal (Zn₁₋ₓMgₓO) of, for example, zinc oxide and magnesium oxide.

Various methods are known for producing a zinc oxide thin film containing a group 2 element. For example, a typical known method in which an inorganic zinc compound is used as a metal source and a starting material is formation of a ZnMgO thin film by sputtering (NPL 1). Meanwhile, a method for formation of a film is known in which an organic zinc compound, which is diethylzinc, is used as a starting material and particularly chemical vapour deposition (CVD) is widely used. Reported examples of CVD include a method in which the organic zinc compound itself is vaporized and used under reduced pressure (NPL 2) and a method in which the organic zinc compound is dissolved in a solvent such as hexane and vaporized together with the solvent to be used (PTL 1).

### CITATION LIST

### Patent Literature

[PTL 1] Japanese Patent Application Laid-open No. 2005-298874
[PTL 2] Japanese Patent Application Laid-open No. 2010-254481
[PTL 3] Japanese Patent Application Laid-open No. 2011-168407
[PTL 4] Japanese Patent Application Laid-open No. 2012-106916

### Non Patent Literature

[NPL 1] “Efficiency Improvement of CIGS Solar Cells Using Sputter-Deposited Buffer Layer”, Masanori Sato, Osamu Watabe, Takashi Nakagawa, Hajime Shibata and Shigeru Niki, The 60th Japan Society of Applied Physics Spring Meeting Abstract 28a-G4-7 (2013, Spring, Kanagawa Institute of Technology)
[NPL 2] “Growth of Polycrystalline Zn₁₋ₓMgₓO Thin Films Using EtCp₂Mg and MeCp₂Mg by Metal Organic Chemical Vapor Deposition” Yoshiyuki Chiba, Fanying Meng, Akira Yamada and Makoto Konagai, Jpn. J. Appl. Phys. 46 (2007) pp. 5040-5043

Entire disclosures of PTL 1 to PTL 4 and NPL 1 and NPL 2 are herein incorporated by reference.

### Summary of Invention

However, when CVD is used for the method for film formation in which diethylzinc is used as a starting material, it is generally required to use a large size vacuum container and the film formation speed is very slow, thus production cost is high. In addition, there is, for example, another problem of difficulty of formation of large zinc oxide thin films because the size of the zinc oxide thin films to be formed is limited by the size of the vacuum container.

In addition, in formation of a zinc oxide thin film containing a group 2 element by CVD, an organic zinc compound and a group 2 element-containing compound are respectively introduced into a film formation device from independent feeding devices and are allowed to react with water to form a zinc oxide thin film containing a group 2 element; however, each element has distinct speed of oxide formation and thus, in order to obtain a desired element composition ratio for the oxides containing zinc and a group 2 element, it is required to strictly control each starting material so that compositional deviation from the starting materials to be supplied does not occur (NPL 2).

As described above, the method for formation of a zinc oxide thin film containing a group 2 element in which diethylzinc is used as a source of zinc element uses CVD, and thus has such problems as, as described above, increased costs for vacuum devices and devices for independently feeding multiple starting materials such as diethylzinc, water and a group 2 element and also requirement for strict control of the supply of the starting materials in order to obtain a desired element composition ratio.

Because of the above problems, there is a need for a convenient method for forming a zinc oxide thin film oxide containing a group 2 element such as by application film formation that does not use a vacuum.

The inventors of the present invention found that it is possible to readily form zinc oxide by using a composition obtained by partial hydrolysis of an alkylzinc such as diethylzinc and heating at a low temperature such as 300° C. or lower after application of the composition (PTL 2, PTL 3 and PTL 4).

However, in a partial hydrolysate obtained from a starting material, alkylzinc such as diethylzinc, containing a group 2 element, a composition for production of a zinc oxide thin film oxide containing a group 2 element suitable for formation of a zinc oxide thin film containing a group 2 element and a method for producing the same have not been known.

An object of the present invention is to provide a composition for producing a zinc oxide thin film containing a group 2 element which allows formation of a zinc oxide thin film containing a group 2 element by application of one component in a method using a partial hydrolysate obtained from a starting material, alkylzinc such as diethylzinc as an organic zinc compound.

### Solution to Problem

The Present Invention is as Follows:

A composition for producing a zinc oxide thin film containing a group 2 element characterised in that the composition is a solution containing a partial hydrolysate of an organic zinc compound represented by the following general formula (1) and the group 2 element dissolved in an organic solvent (wherein, the solution may further contain a group 13 element):

### (Organic Zinc Compound)

R¹—Zn—R¹ (1)

(wherein R¹ is a C₁₋₇ linear or branched alkyl group).

The composition for producing the zinc oxide thin film according to claim 1, wherein the group 2 element is contained as at least one compound selected from the group consisting of
a group 2 element organic compound A represented by the following general formula (2),
a hydrolysate obtained by at least partially hydrolysing the group 2 element organic compound A,
a group 2 element organic compound B represented by the following general formula (3), a hydrolysate obtained by at least partially hydrolysing the group 2 element organic compound B, and
a group 2 element inorganic compound represented by the following general formula (4):
(Group 2 Element Organic Compound A)

R²-M-R².(L)n (2)

(wherein M is the group 2 element; R² is independently hydrogen, a C₁₋₈ linear or branched alkyl group, a C₁₋₇ linear or branched alkoxyl group, an acyloxy group or an acetylacetonate group; L is a nitrogen-, oxygen- or phosphorus-containing coordinating organic compound; and n is an integer of 0 to 9);

### (Group 2 Element Organic Compound B)

R³-M-X.(L)n (³)

(wherein M is the group 2 element; R³ is a C₁₋₈ linear or branched alkyl group; X is a halogen atom; L is a nitrogen-, oxygen- or phosphorus-containing coordinating organic compound; and n is an integer of 0 to 9);

### (Group 2 Element Inorganic Compound)

M_{c}Y_{d}.aH₂O (4)

(wherein M is the group 2 element; Y is hydrogen, a halogen atom, a nitrate group (NO₃⁻) or a sulphate group (SO₄²⁻); when Y is hydrogen, a halogen atom or a nitrate group, c is 1 and d is 2; when Y is a sulphate group, c is 1 and d is 1; and a is an integer of 0 to 9).

The composition for producing the zinc oxide thin film according to claim 1 or 2, wherein the group 13 element is contained as at least one compound selected from the group consisting of a group 13 element organic compound represented by the following general formula (5), a hydrolysate obtained by at least partially hydrolysing the group 13 element organic compound and a group 13 element inorganic compound represented by the following general formula (6):

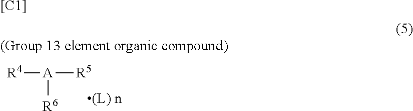

(wherein A is the group 13 element; R⁴, R⁵ and R⁶ are independently hydrogen, a C₁₋₈ linear or branched alkyl group, a C₁₋₇ linear or branched alkoxyl group, an acyloxy group or an acetylacetonate group; L is a nitrogen-, oxygen- or phosphorus-containing coordinating organic compound; and n is an integer of 0 to 9);

### (Group 13 Element Inorganic Compound)

AₑZ_{f}.aH₂O (6)

(wherein A is the group 13 element; Z is a halogen atom, a nitrate group (NO₃⁻) or a sulphate group (SO₄²⁻); when Z is a halogen atom or a nitrate group, e is 1 and f is 3; when Z is a sulphate group, e is 2 and f is 3; and a is an integer of 0 to 9).

The composition for producing the zinc oxide thin film according to any of claims 1 to 3, wherein:
the partial hydrolysate of the organic zinc compound represented by the general formula (1),
the hydrolysate obtained by at least partially hydrolysing the group 2 element organic compound A represented by the general formula (2),
the hydrolysate obtained by at least partially hydrolysing the group 2 element organic compound B represented by the general formula (3), and
the hydrolysate obtained by at least partially hydrolysing the group 13 element organic compound represented by the general formula (5) are
products obtained by partially or at least partially hydrolysing the compounds with water in a range of a molar ratio of equal to or more than 0.05 to equal to or less than 0.8 relative to the respective compounds, or at least partly or entirely are products obtained by partially or at least partially hydrolysing the respective compounds with water in a range of a molar ratio of equal to or more than 0.05 to equal to or less than 0.8 relative to the total number of moles of the compounds.

The composition for producing the zinc oxide thin film according to any of claims 1 to 4, wherein the total number of moles of the group 2 element organic compound A, the group 2 element organic compound B and the group 2 element inorganic compound (including the hydrolysates) is in the proportion of 0.001 to 4 relative to the number of moles of the organic zinc compound (including the partial hydrolysate).

The composition for producing the zinc oxide thin film according to any of claims 1 to 5, comprising zinc, the group 2 element and the group 13 element.

The composition for producing the zinc oxide thin film according to claim 6, wherein the total number of moles of the group 13 element organic compound and the group 13 element inorganic compound (including the hydrolysate) is in the proportion of 0.000001 to 0.5 relative to the number of moles of the organic zinc compound (including the partial hydrolysate).

The composition according to any of claims 1 to 7, wherein the total concentration of the partial hydrolysate of the organic zinc compound, the hydrolysate obtained by at least partially hydrolysing the group 2 element organic compound A, the hydrolysate obtained by at least partially hydrolysing the group 2 element organic compound B and the hydrolysate obtained by at least partially hydrolysing the group 13 element organic compound is in the range of 0.1 mass % to 30 mass %.

The composition according to any of claims 1 to 8, wherein the organic zinc compound is a compound wherein R¹ is a C₁₋₆ alkyl group.

The composition according to any of claims 1 to 8, wherein the organic zinc compound is diethylzinc.

The composition according to any of claims 1 to 10, wherein the group 2 element is at least one selected from the group consisting of Ca, Mg, Ba and Sr.

The composition according to claim 11, wherein the group 2 element is Mg.

The composition according to any of claims 1 to 12, wherein the group 2 element organic compound A is a compound wherein R² is a C₁₋₈ alkyl group.

The composition according to claim 13, wherein the group 2 element organic compound A is ethylbutylmagnesium or dibutylmagnesium.

The composition according to any of claims 1 to 14, wherein the organic group 13 element is at least one selected from the group consisting of B, Al, Ga and In.

The composition according to claim 15, wherein the group 13 element organic compound is a compound wherein R⁴, R⁵ and R⁶ are independently a C₁₋₈ alkyl group.

The composition according to claim 16, wherein the group 13 element organic compound is trimethylaluminium, triethylaluminium, trimethylgallium, triethylgallium, trimethylindium or triethylindium.

The composition for producing the zinc oxide thin film according to claims 1 to 17, wherein the organic solvent is an electron donating organic solvent and/or a hydrocarbon compound.

A method for producing the composition for producing a zinc oxide thin film containing a group 2 element according to any of claims 1 to 18, including a solution containing a partial hydrolysate of the organic zinc compound represented by the general formula (1) and a group 2 element dissolved in an organic solvent (wherein the solution may further contain a group 13 element), the method comprising any of following steps [1] to [6]:
step [1]: a step of adding water to an organic solvent containing the organic zinc compound represented by the general formula (1) and a group 2 element organic compound A represented by the general formula (2) to partially hydrolyse the organic zinc compound and at least partially hydrolyse the group 2 element organic compound A, thereby obtaining a composition containing hydrolysates (including partial hydrolysates) dissolved in the organic solvent (wherein the amount of water added may be in a range of a molar ratio of equal to or more than 0.05 to equal to or less than 0.8 relative to the total number of moles of the compounds);
step [2]: a step of independently or altogether mixing an organic solvent containing the organic zinc compound represented by the general formula (1), an organic solvent containing the group 2 element organic compound A represented by the general formula (2) and a group 13 element organic compound represented by the general formula (5) and water to partially hydrolyse the organic zinc compound and at least partially hydrolyse the group 2 element organic compound A and the group 13 element organic compound, thereby obtaining a composition containing hydrolysates (including partial hydrolysates) dissolved in the organic solvent (wherein the amount of water added may be in a range of a molar ratio of equal to or more than 0.05 to equal to or less than 0.8 relative to the total number of moles of the compounds);
step [3]: a step of adding, to an organic solvent containing the organic zinc compound represented by the general formula (1), an organic solvent containing at least one compound selected from the group consisting of the group 2 element organic compound A represented by the general formula (2), the group 2 element organic compound B represented by the general formula (3) and a group 2 element inorganic compound represented by the general formula (4) and water independently or altogether to partially hydrolyse the organic zinc compound and at least partially hydrolyse the group 2 element organic compound A and the group 2 element organic compound B, thereby obtaining a composition containing hydrolysates (including partial hydrolysates) dissolved in the organic solvent (wherein the amount of water added may be in a range of a molar ratio of equal to or more than 0.05 to equal to or less than 0.8 relative to the total number of moles of the compounds (wherein the group 2 element inorganic compound represented by the general formula (4) is excluded));
step [4]: a step of mixing an organic solvent containing the organic zinc compound represented by the general formula (1) with an organic solvent containing at least one compound selected from the group consisting of the group 2 element organic compound A represented by the general formula (2), the group 2 element organic compound B represented by the general formula (3) and the group 2 element inorganic compound represented by the general formula (4), an organic solvent containing at least one compound selected from the group consisting of the group 13 element organic compound represented by the general formula (5) and a group 13 element inorganic compound represented by the general formula (6) and water independently or altogether to partially hydrolyse the organic zinc compound and at least partially hydrolyse the group 2 element organic compound A, the group 2 element organic compound B and the group 13 element organic compound, thereby obtaining a composition containing hydrolysates (including partial hydrolysates) dissolved in the organic solvent (wherein the amount of water added may be in a range of a molar ratio of equal to or more than 0.05 to equal to or less than 0.8 relative to the total number of moles of the compounds (wherein the group 2 element inorganic compound represented by the general formula (4) and the group 13 element inorganic compound represented by the general formula (6) are excluded));
step [5]: a step of adding water to an organic solvent containing the organic zinc compound represented by the general formula (1) to obtain a partial hydrolysate of the organic zinc compound (wherein the amount of water added may be in a range of a molar ratio of equal to or more than 0.05 to equal to or less than 0.8 relative to the organic zinc compound) and then adding, to the obtained organic solvent containing the partial hydrolysate of the organic zinc compound, an organic solvent containing at least one compound selected from the group consisting of the group 2 element organic compound A represented by the general formula (2), the group 2 element organic compound B represented by the general formula (3), the group 2 element inorganic compound represented by the general formula (4), a hydrolysate obtained by at least partially hydrolysing the group 2 element organic compound A and a hydrolysate obtained by at least partially hydrolysing the group 2 element organic compound B to obtain a composition (wherein the amount of water added for at least partially hydrolysing each of the group 2 element organic compound A and the group 2 element organic compound B may be in a range of a molar ratio of equal to or more than 0.05 to equal to or less than 0.8, and when a mixture of the group 2 element organic compound A and the group 2 element organic compound B is hydrolysed, the amount of water added may be in a range of a molar ratio of equal to or more than 0.05 to equal to or less than 0.8 relative to the total number of moles of the compounds);
step [6]: a step of adding water to an organic solvent containing the organic zinc compound represented by the general formula (1) to obtain a partial hydrolysate of the organic zinc compound (wherein the amount of water added may be in a range of a molar ratio of equal to or more than 0.05 to equal to or less than 0.8 relative to the organic zinc compound) and then adding, to the obtained organic solvent containing the partial hydrolysate of the organic zinc compound, an organic solvent containing at least one compound selected from the group consisting of the group 2 element organic compound A represented by the general formula (2), the group 2 element organic compound B represented by the general formula (3), the group 2 element inorganic compound represented by the general formula (4), a hydrolysate obtained by at least partially hydrolysing the group 2 element organic compound A and a hydrolysate obtained by at least partially hydrolysing the group 2 element organic compound B and at least one compound selected from the group consisting of the group 13 element organic compound represented by the general formula (5), a hydrolysate obtained by at least partially hydrolysing the group 13 element organic compound and the group 13 element inorganic compound represented by the general formula (6) to obtain a composition (wherein the amount of water added for at least partially hydrolysing each of the group 2 element organic compound A, the group 2 element organic compound B and the group 13 element organic compound may be in a range of a molar ratio of equal to or more than 0.05 to equal to or less than 0.8, and when a mixture of the group 2 element organic compound A, the group 2 element organic compound B and the group 13 element organic compound is hydrolysed, the amount of water added may be in a range of a molar ratio of equal to or more than 0.05 to equal to or less than 0.8 relative to the total number of moles of the compounds).

The method according to claim 19, wherein in the step [2] or [3], water is added in a range of a molar ratio of equal to or more than 0.05 to equal to or less than 0.8 relative to the total number of moles of the organic zinc compound represented by the general formula (1), the group 2 element organic compound A represented by the general formula (2) and the group 2 element organic compound B represented by the general formula (3) to partially hydrolyse the organic zinc compound and at least partially hydrolyse the group 2 element organic compound A and the group 2 element organic compound B.

The method according to claim 19, wherein in the step [4], water is added in the range of a molar ratio of equal to or more than 0.05 to equal to or less than 0.8 relative to the total number of moles of the organic zinc compound represented by the general formula (1), the group 2 element organic compound A represented by the general formula (2), the group 2 element organic compound B represented by the general formula (3) and the group 13 element organic compound represented by the general formula (5) to partially hydrolyse the organic zinc compound and at least partially hydrolyse the group 2 element organic compound A, the group 2 element organic compound B and the group 13 element organic compound.

### Advantageous Effects of Invention

According to the present invention, a zinc oxide thin film containing a group 2 element can be easily produced only by application and heating. Further, a composition for producing a zinc oxide thin film containing a group 2 element can also be produced which allows easy production of the zinc oxide thin film containing the group 2 element.

### BRIEF DESCRIPTION OF DRAWINGS

FIG. 1 is a drawing illustrating a spray film formation device.

FIG. 2 is a ¹H-NMR spectrum of the composition obtained in Example 4 after concentration under reduced pressure.

FIG. 3 is a ¹H-NMR spectrum of diethylzinc (manufactured by Tosoh Finechem Corporation) used as a starting material of the composition obtained in Example 4.

FIG. 4 is a ¹H-NMR spectrum of dibutylmagnesium (1 mol/L heptane solution (containing triethylaluminium (1 wt % or less)), manufactured by Sigma-Aldrich Co. LLC.) after concentration under reduced pressure, which was used as a starting material of the composition obtained in Example 4.

FIG. 5 is a ¹H-NMR spectrum of 1,2-diethoxyethane used as a starting material of the composition obtained in Example 4.

FIG. 6 is a FT-IR spectrum of the composition obtained in Example 4 after concentration under reduced pressure.

FIG. 7 is a scanning electron micrograph (thin film surface) of the zinc oxide thin film containing a group 2 element obtained in Reference Example 1.

FIG. 8 is a scanning electron micrograph (thin film cross-section) of the zinc oxide thin film containing a group 2 element obtained in Reference Example 1.

FIG. 9 is a scanning electron micrograph (thin film surface) of the zinc oxide thin film containing a group 2 element obtained in Reference Example 2.

FIG. 10 is a scanning electron micrograph (thin film cross-section) of the zinc oxide thin film containing a group 2 element obtained in Reference Example 2.

FIG. 11 is an XRD chart of the zinc oxide thin film containing a group 2 element obtained in Reference Example 2.

FIG. 12 shows the transmission at or below 600 nm of zinc oxide thin films containing a group 2 element obtained in Reference Example 1 and Reference Examples 3 to 5 as described in Reference Example 10.

FIG. 13 shows the transmission at or below 600 nm of zinc oxide thin films containing a group 2 element obtained in Reference Examples 6 to 8 as described in Reference Example 11.

FIG. 14 is an XRD chart of the zinc oxide thin film containing a group 2 element obtained in Reference Example 13.

### DESCRIPTION OF EMBODIMENTS

[Composition for Producing a Zinc Oxide Thin Film Containing a Group 2 Element]

The present invention which is sought to solve the above problems is now described in more detail.

The composition for producing a zinc oxide thin film containing a group 2 element of the present invention is any of the following composition A, composition B and composition C.

<Composition A>

The composition A is a composition for producing a zinc oxide thin film containing a group 2 element characterised in that the composition is a solution containing a partial hydrolysate of an organic zinc compound represented by the following general formula (1) and a group 2 element dissolved in an organic solvent and the solution may further contain a group 13 element:

### (Organic Zinc Compound)

R¹—Zn—R¹ (1)

(wherein R¹ is a C₁₋₇ linear or branched alkyl group).

<Composition B>

The composition B is a composition characterised in that, in the composition A, the group 2 element is contained as at least one compound selected from the group consisting of
a group 2 element organic compound A represented by the following general formula (2), a hydrolysate obtained by at least partially hydrolysing the group 2 element organic compound A,
a group 2 element organic compound B represented by the following general formula (3), a hydrolysate obtained by at least partially hydrolysing the group 2 element organic compound B and
a group 2 element inorganic compound represented by the following general formula (4):

### (Group 2 Element Organic Compound A)

R²-M-R².(L)n (2)

(wherein M is the group 2 element; R² is independently hydrogen, a C₁₋₈ linear or branched alkyl group, a C₁₋₇ linear or branched alkoxyl group, an acyloxy group or an acetylacetonate group; L is a nitrogen-, oxygen- or phosphorus-containing coordinating organic compound; and n is an integer of 0 to 9);

### (Group 2 Element Organic Compound B)

R³-M-X.(L)n (³)

(wherein M is the group 2 element; R³ is a C₁₋₈ linear or branched alkyl group; X is a halogen atom; L is a nitrogen-, oxygen- or phosphorus-containing coordinating organic compound; and n is an integer of 0 to 9);

### (Group 2 Element Inorganic Compound)

M_{c}Y_{d}.aH₂O (4)

(wherein M is the group 2 element; Y is hydrogen, a halogen atom, a nitrate group (NO₃⁻) or a sulphate group (SO₄²⁻); when Y is hydrogen, a halogen atom or a nitrate group, c is 1 and d is 2; when Y is a sulphate group, c is 1 and d is 1; and a is an integer of 0 to 9).

<Composition C>

The composition C is a composition characterised in that, in the composition A and the composition B, the group 13 element is contained as at least one compound selected from the group consisting of a group 13 element organic compound represented by the following general formula (5), a hydrolysate obtained by at least partially hydrolysing the group 13 element organic compound and a group 13 element inorganic compound represented by the following general formula (6):

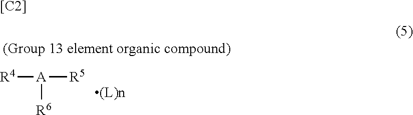

(wherein A is the group 13 element; R⁴, R⁵ and R⁶ are independently hydrogen, a C₁₋₈ linear or branched alkyl group, a C₁₋₇ linear or branched alkoxyl group, an acyloxy group or an acetylacetonate group; L is a nitrogen-, oxygen- or phosphorus-containing coordinating organic compound; and n is an integer of 0 to 9);

### (Group 13 Element Inorganic Compound)

AₑZ_{f}.aH₂O (6)

(wherein A is the group 13 element; Z is a halogen atom, a nitrate group (NO₃⁻) or a sulphate group (SO₄²⁻); when Z is a halogen atom or a nitrate group, e is 1 and f is 3; when Z is a sulphate group, e is 2 and f is 3; and a is an integer of 0 to 9).

In the compositions A, B and C,
the partial hydrolysate of the organic zinc compound represented by the general formula (1),
the hydrolysate obtained by at least partially hydrolysing the group 2 element organic compound A represented by the general formula (2),
the hydrolysate obtained by at least partially hydrolysing the group 2 element organic compound B represented by the general formula (3) and
the hydrolysate obtained by at least partially hydrolysing the group 13 element organic compound represented by the general formula (5) are
products obtained by partially or at least partially hydrolysing the compounds with water in the range of a molar ratio of equal to or more than 0.05 to equal to or less than 0.8 relative to the respective compounds, or at least partly or entirely are products obtained by partially or at least partially hydrolysing the respective compounds with water in the range of a molar ratio of equal to or more than 0.05 to equal to or less than 0.8 relative to the total number of moles of the compounds. The molar ratio of water used for preparation of partial hydrolysates is preferably in the range of 0.3 to 0.75 inclusive and still more preferably in the range of 0.4 to 0.7 inclusive.

The hydrolysate obtained by at least partially hydrolysing the group 2 element organic compound A represented by the general formula (2), the hydrolysate obtained by at least partially hydrolysing the group 2 element organic compound B represented by the general formula (3) and the hydrolysate obtained by at least partially hydrolysing the group 13 element organic compound represented by the general formula (5) mean that each hydrolysate is a partial hydrolysate obtained by partially hydrolysing each compound, a complete hydrolysate obtained by completely hydrolysing each compound or a mixture of the foregoing.

Further, in the compositions B and C, the total number of moles of the group 2 element organic compound A, the group 2 element organic compound B and the group 2 element inorganic compound (including the hydrolysates) may be in the proportion of 0.001 to 4 relative to the number of moles of the organic zinc compound (including the partial hydrolysate). The proportion (molar ratio) is preferably in the range of 0.001 to 0.5. Namely, the group 2 element organic compound A and the group 2 element organic compound B comprise hydrolysates obtained by at least partially hydrolysing the compounds and the organic zinc compound comprises a partial hydrolysate.

It is preferable that C comprises zinc, the group 2 element and the group 13 element, and it is still more preferable that the total number of moles of the group 13 element organic compound and the group 13 element inorganic compound (including the hydrolysate) is in the proportion of 0.000001 to 0.5 relative to the number of moles of the organic zinc compound (including the partial hydrolysate). The proportion (molar ratio) is preferably in the range of 0.00001 to 0.1. Namely, the group 13 element organic compound comprises a hydrolysate obtained by at least partially hydrolysing the compound and the organic zinc compound comprises a partial hydrolysate.

Specific examples of the alkyl group represented by R¹ in the organic zinc compound represented by the general formula (1) may include a methyl group, an ethyl group, a propyl group, an isopropyl group, a butyl group, an isobutyl group, a sec-butyl group, a tert-butyl group, a pentyl group, an isopentyl group, a neopentyl group, a tert-pentyl group, a hexyl group, an isohexyl group, a sec-hexyl group, a tert-hexyl group, a 2-hexyl group and a heptyl group. The compound represented by the general formula (1) is preferably a compound wherein R¹ has 1, 2, 3, 4, 5 or 6 carbon atoms. The compound represented by the general formula (1) is particularly preferably diethylzinc in which R¹ has 2 carbon atoms.

For the group 2 element organic compound A represented by the general formula (2), examples of the metal represented by M may include Ca, Mg, Ba and Sr, among which Mg is particularly preferable. It is also preferable that R² is hydrogen, an alkyl group or a cyclopentadienyl group. Specific examples of the alkyl group may include a methyl group, an ethyl group, a propyl group, an isopropyl group, a butyl group, an isobutyl group, a sec-butyl group, a tert-butyl group, a pentyl group, an isopentyl group, a neopentyl group, a tert-pentyl group, a hexyl group, an isohexyl group, a sec-hexyl group, a tert-hexyl group, a 2-hexyl group and a heptyl group. Examples of the cyclopentadienyl group may include a cyclopentadienyl group, a methylcyclopentadienyl group, an ethylcyclopentadienyl group and a pentamethylcyclopentadienyl group. Examples of the ligand represented by L may include trimethylamine, triethylamine, triphenylamine, pyridine, monopholine, N,N-dimethylaniline, N,N-diethylaniline, triphenylphosphine, dimethylsulphur, diethyl ether and tetrahydrofuran. Examples of the group 2 element organic compound A represented by the general formula (2) may particularly include ethylbutylmagnesium, di-n-butylmagnesium, di-sec-butylmagnesium, di-tert-butylmagnesium, dihexylmagnesium, dioctylmagnesium, biscyclopentadienylmagnesium and bispentamethylcyclopentadienylmagnesium, among which ethylbutylmagnesium, dibutylmagnesium, dihexylmagnesium, dioctylmagnesium and biscyclopentadienyl are preferred and ethylbutylmagnesium and dibutylmagnesium are particularly preferred because of the low price and availability thereof.

The group 2 element organic compound A represented by the general formula (2) in which R² and R³ are hydrogen, an alkyl group or an alkyl group which is a cyclopentadienyl group may be used as a solution in an electron donating organic solvent or a hydrocarbon compound which may be used as the solvent in the present invention. For example, the compound may be used as a solution in a hydrocarbon compound, which may be used as the solvent in the present invention, such as a solution of an alkylmagnesium compound such as ethylbutylmagnesium and dibutylmagnesium in hexane, heptane, octane or toluene; and a solution of a cyclopentadienylmagnesium such as biscyclopentadienylmagnesium in toluene.

In order to improve the solubility and stability of an alkylmagnesium compound in a hydrocarbon compound solution, it is generally known that an alkylmetal compound containing a group 13 such as alkylaluminium represented by element such as triethylaluminium and trioctylaluminium is allowed to co-exist. In the present invention as well, a solution of an alkylmagnesium compound in a hydrocarbon compound in which an alkylmetal compound containing a group 13 element such a alkylaluminium co-exists may be used and for example, an ethylbutylmagnesium/heptane solution (containing triethylaluminium) and a dibutylmagnesium/heptane (containing triethylaluminium) solution may be used.

The compound wherein R² is an alkoxy group such as a methoxy group, an ethoxy group, a n-propoxy group, a sec-propoxy group, a n-butoxy group, a sec-butoxy group, a tert-butoxy group, a phenoxy group and a methoxyethoxy group; an acyloxy group such as an acetoxy group, a propionyloxy group, a butylyloxy group and an isobutylyloxy group; or an acetylacetonate group may also be used. Specific examples thereof include diethoxycaclium, dimethoxymagnesium, diethoxymagnesium, di-i-propoxymagnesium, di-n-butoxymagnesium, di-sec-butoxymagnesium, diethoxybarium, di-tert-butoxybarium, di-i-propoxystrontium, calcium acetate, magnesium acetate, barium acetate, strontium acetate, calcium acetylacetonate, magnesium acetylacetonate, barium acetylacetonate and strontium acetylacetonate.

Examples of the metal represented by M in the group 2 element organic compound B represented by the general formula (3) may include Ca, Mg, Ba and Sr, among which Mg is particularly preferable. It is also preferable that R³ is an alkyl group, an aryl group or a cyclopentadienyl group. Specific examples of the alkyl group may include a methyl group, an ethyl group, a propyl group, an isopropyl group, a butyl group, an isobutyl group, a sec-butyl group, a tert-butyl group, a pentyl group, an isopentyl group, a neopentyl group, a tert-pentyl group, a hexyl group, an isohexyl group, a sec-hexyl group, a tert-hexyl group, a 2-hexyl group and a heptyl group. Specific examples of the aryl group may include a phenyl group and a tolyl group and examples of the cyclopentadienyl group may include a cyclopentadienyl group, a methylcyclopentadienyl group, an ethylcyclopentadienyl group and a pentamethylcyclopentadienyl group. Examples of X in the general formula (3) include chlorine, bromine and iodine.

Examples of the group 2 element organic compound B represented by the general formula (3) may particularly include methylmagnesium iodide, methylmagnesium chloride, methylmagnesium bromide, ethylmagnesium chloride, ethylmagnesium bromide, isopropylmagnesium chloride, butylmagnesium chloride, butylmagnesium bromide, phenylmagnesium chloride and phenylmagnesium bromide.

The group 2 element organic compound B represented by the general formula (3) in which M is Mg is well-known as a Grignard reagent. The reagent may be supplied as a solution in an electron donating organic solvent which may be used as the solvent in the present invention. For example, the compound may be used as a solution in an electron donating organic solvent such as a solution of an alkylmagnesium compound such as ethylbutylmagnesium and dibutylmagnesium in tetrahydrofuran, diethyl ether, diisopropyl ether, dibutyl ether and anisole.

Specific examples of the metal represented as M in the group 2 element inorganic compound represented by the general formula (4) may include Ca, Mg, Ba and Sr. Specific examples of the salt represented by Y may include hydrogen, fluorine, chlorine, bromine, iodine, nitric acid, sulphuric acid, phosphoric acid and carbonic acid.

Examples of the group 2 element inorganic compound represented by the general formula (4) include calcium chloride, magnesium chloride, barium chloride, strontium chloride, calcium nitrate, magnesium nitrate, barium nitrate, strontium nitrate, calcium sulphate, magnesium sulphate, barium sulphate, strontium sulphate, calcium phosphate, magnesium phosphate, calcium carbonate and magnesium carbonate and inorganic hydrides such as calcium hydride and magnesium hydride.

Specific examples of the metal represented by M in the group 13 element organic compound represented by the general formula (5) may include B, Al, Ga and In. It is also preferred that R⁴, R⁵ and R⁶ are hydrogen or an alkyl group. Specific examples of the alkyl group may include a methyl group, an ethyl group, a propyl group, an isopropyl group, a butyl group, an isobutyl group, a sec-butyl group, a tert-butyl group, a pentyl group, an isopentyl group, a neopentyl group, a tert-pentyl group, a hexyl group, an isohexyl group, a sec-hexyl group, a tert-hexyl group, a 2-hexyl group and a heptyl group. It is also preferred that at least one of R⁴, R⁵ and R⁶ is hydrogen and the rest is an alkyl group. Examples of the ligand represented by L may include trimethylamine, triethylamine, triphenylamine, pyridine, monopholine, N,N-dimethylaniline, N,N-diethylaniline, triphenylphosphine, dimethylsulphur, diethyl ether and tetrahydrofuran.

Examples of the group 13 element organic compound represented by the general formula (5) may particularly include diborane, a borane-tetrahydrofuran complex, a borane-trimethylamine complex, a borane-triethylamine complex, triethylborane, tributylborane, an alane-trimethylamine complex, an alane-triethylamine complex, trimethylaluminium, triethylaluminium, dimethylaluminium hydride, triisobutylaluminium, diisobutylaluminium hydride, trihexylaluminium, trioctylaluminium, trimethylgallium, triethylgallium, trimethylindium and triethylindium. Trimethylaluminium, triethylaluminium, triisobutylaluminium, trimethylgallium, trimethylindium and triethylindium are particularly preferred because of the low price and availability thereof.

The compound in which R⁴, R⁵ and R⁶ are an alkoxy group such as a methoxy group, an ethoxy group, a n-propoxy group, a sec-propoxy group, a n-butoxy group, a sec-butoxy group, a tert-butoxy group, a phenoxy group and a methoxyethoxy group, an acyloxy group such as an acetoxy group, a propionyloxy group, a butylyloxy group and an isobutylyloxy group or an acetylacetonate group may also be used. Specific examples thereof include trimethyl borate, triethyl borate, triethyl borate, tri-n-butyl borate, aluminium triethoxide, aluminium triisopropoxide, aluminium sec-butoxide, aluminium n-butoxide, aluminium tert-butoxide, gallium triethoxide, gallium triisopropoxide, gallium sec-butoxide, gallium n-butoxide, gallium tert-butoxide, indium triethoxide, indium triisopropoxide, indium sec-butoxide, indium n-butoxide, indium tert-butoxide, aluminium acetate, gallium acetate, indium acetate, aluminium triacetylacetonate, gallium triacetylacetonate, indium acetylacetonate and the like.

Specific examples of the metal represented by M in the group 13 element inorganic compound represented by the general formula (6) include B, Al, Ga and In. Specific examples of the salt represented by Z include fluorine, chlorine, bromine, iodine, nitric acid, sulphuric acid and phosphoric acid.

Particularly, examples of the group 13 element inorganic compound represented by the general formula (6) include boron chloride, aluminium chloride hexahydrate, aluminium nitrate nonahydrate, gallium chloride, gallium nitrate hydrate, indium chloride tetrahydrate and indium nitrate pentahydrate.

The organic solvent may be the one which is soluble in the group 2 element organic compound A, the group 2 element organic compound B, the organic zinc compound, the group 13 element organic compound and water. Particularly, an electron donating organic solvent, a hydrocarbon solvent and a mixture thereof is preferably used. The organic solvent may also be the one which is soluble in water, or an organic solvent which is soluble in water and an organic solvent which is less soluble in water may be used in combination.

Examples of the electron donating organic solvent include an ether solvent such as 1,2-diethoxyethane, 1,2-dibutoxyethane, diethyl ether, di-n-propyl ether, di-isopropyl ether, dibutyl ether, tetrahydrofuran, dioxane, glyme, diglyme, triglyme, anisole and methoxytoluene, an amine solvent such as trimethylamine, triethylamine and triphenylamine. The electron donating solvent is preferably 1,2-diethoxyethane, tetrahydrofuran and dioxane.

In the present invention, the solvent used may be a hydrocarbon compound. Examples of the hydrocarbon compound include a C₅₋₂₀, more preferably C₆₋₁₂, linear or branched hydrocarbon compound or cyclic hydrocarbon compound, a C₆₋₂₀, more preferably C₆₋₁₂, aromatic hydrocarbon compound and a mixture thereof.

Specific examples of the hydrocarbon compound include an aliphatic hydrocarbon such as pentane, n-hexane, heptane, isohexane, methylpentane, octane, 2,2,4-trimethylpentane (isooctane), n-nonane, n-decane, n-hexadecane, octadecane, eicosane, methylheptane, 2,2-dimethylhexane and 2-methyloctane; an alicyclic hydrocarbon such as cyclopentane, cyclohexane, methylcyclohexane and ethylcyclohexane; an aromatic hydrocarbon such as benzene, toluene, xylene, cumene and trimethylbenzene; and a hydrocarbon solvent such as mineral spirit, solvent naphtha, kerosene and petroleum ether.

[Method for Producing a Composition for Producing a Zinc Oxide Thin Film Containing a Group 2 Element]

The present invention encompasses a method for producing the composition for producing a zinc oxide thin film containing a group 2 element of the present invention. The composition includes, as described above, a solution containing a partial hydrolysate of the organic zinc compound represented by the above general formula (1) and a group 2 element dissolved in an organic solvent (wherein the solution may further contain a group 13 element). The production method of the present invention includes any of the following steps [1] to [6].

The step [1] is the step of adding water to an organic solvent containing the organic zinc compound represented by the general formula (1) and the group 2 element organic compound A represented by the general formula (2) to partially hydrolyse the organic zinc compound and at least partially hydrolyse the group 2 element organic compound A, thereby obtaining the composition containing hydrolysates (including partial hydrolysates) dissolved in the organic solvent. In the step, water is added to the organic solvent containing the organic zinc compound and the group 2 element organic compound A, and thus the organic zinc compound and the group 2 element organic compound A are hydrolysed under almost the same condition to form a mixture of partial hydrolysates. The amount of water added may be in the range of a molar ratio of equal to or more than 0.05 to equal to or less than 0.8 relative to the total number of moles of the compounds. The amount of water added may preferably be in the range of a molar ratio of 0.3 to 0.75 inclusive and still more preferably 0.4 to 0.7 inclusive relative to the total number of moles of the compounds.

The step [1] also encompasses a method in which water is added to an organic solvent containing at least one selected from the group 2 element organic compound A, the group 2 element organic compound B and the group 2 element compound and the organic zinc compound dissolved therein to obtain a composition containing a hydrolysate obtained by at least partially hydrolysing at least one compound selected from the group 2 element organic compound A and the group 2 element organic compound B and a partial hydrolysate obtained by partially hydrolysing the organic zinc compound.

The step [2] is the step of independently or altogether mixing an organic solvent containing the organic zinc compound represented by the general formula (1), an organic solvent containing the group 2 element organic compound A represented by the general formula (2) and the group 13 element organic compound represented by the general formula (5) and water to partially hydrolyse the organic zinc compound and at least partially hydrolyse the group 2 element organic compound A and the group 13 element organic compound, thereby obtaining the composition containing hydrolysates (including partial hydrolysates) dissolved in the organic solvent.

The step encompasses:
an embodiment in which water is added to an organic solvent containing the organic zinc compound, the group 2 element organic compound A and the group 13 element organic compound;
an embodiment in which to an organic solvent containing the organic zinc compound an organic solvent containing the group 2 element organic compound A and the group 13 element organic compound and water are added; and
an embodiment in which to an organic solvent containing the group 2 element organic compound A and the group 13 element organic compound an organic solvent containing the organic zinc compound and water are added.

It is known that the organic zinc compound, the group 2 element organic compound A and the group 13 element organic compound react differently with water and there is a tendency that hydrolysis of the group 2 element organic compound A and the group 13 element organic compound proceeds with priority to hydrolysis of the organic zinc compound. Although the conditions of hydrolysis vary according to the embodiments of addition as described above, the organic zinc compound forms a partial hydrolysate and the group 2 element organic compound A and the group 13 element organic compound form hydrolysates which are at least partially hydrolysed. Here, the amount of water added may be in the range of a molar ratio of equal to or more than 0.05 to equal to or less than 0.8 relative to the total number of moles of the compounds. The amount of water added may be preferably in the range of a molar ratio of 0.3 to 0.75 inclusive and still more preferably in the range of 0.4 to 0.7 inclusive relative to the total number of moles of the compounds.

The step [3] is the step of adding, to an organic solvent containing the organic zinc compound represented by the general formula (1), an organic solvent containing at least one compound selected from the group consisting of the group 2 element organic compound A represented by the general formula (2), the group 2 element organic compound B represented by the general formula (3) and the group 2 element inorganic compound represented by the general formula (4) and water independently or altogether to partially hydrolyse the organic zinc compound and at least partially hydrolyse the group 2 element organic compound A and the group 2 element organic compound B, thereby obtaining the composition containing hydrolysates (including partial hydrolysates) dissolved in the organic solvent. In the step, to an organic solvent containing the organic zinc compound, an organic solvent containing at least one compound selected from the group consisting of the group 2 element organic compound A, the group 2 element organic compound B and the group 2 element inorganic compound and water are independently, i.e. separately or altogether added, i.e. a mixture of an organic solvent containing the compound(s) and water is added. There is a tendency that hydrolysis of the group 2 element organic compound A and the group 2 element organic compound B proceeds with priority to hydrolysis of the organic zinc compound. However, the tendency may change according to stirring of the solution or the manner and condition of addition of water. As a result, a mixture of a partial hydrolysate of the organic zinc compound and hydrolysates obtained by at least partially hydrolysing the group 2 element organic compound A and the group 2 element organic compound B is obtained. The amount of water added may be in the range of a molar ratio of equal to or more than 0.05 to equal to or less than 0.8 relative to the total number of moles of the compounds (wherein the group 2 element inorganic compound represented by the general formula (4) is excluded). The amount of water added may be preferably in the range of a molar ratio of 0.3 to 0.75 inclusive and still more preferably in the range of 0.4 to 0.7 inclusive relative to the total number of moles of the compounds.

In the step [4], an organic solvent containing the organic zinc compound represented by the general formula (1) is mixed with an organic solvent containing at least one compound selected from the group consisting of the group 2 element organic compound A represented by the general formula (2), the group 2 element organic compound B represented by the general formula (3) and the group 2 element inorganic compound represented by the general formula (4), an organic solvent containing at least one compound selected from the group consisting of the group 13 element organic compound represented by the general formula (5) and the group 13 element inorganic compound represented by the general formula (6) and water independently or altogether to partially hydrolyse the organic zinc compound and at least partially hydrolyse the group 2 element organic compound A, the group 2 element organic compound B and the group 13 element organic compound, thereby obtaining the composition containing hydrolysates (including partial hydrolysates) dissolved in the organic solvent.

The step may be the step of adding to an organic solvent containing the organic zinc compound represented by the general formula (1) an organic solvent containing at least one compound selected from the group consisting of the group 2 element organic compound A represented by the general formula (2), the group 2 element organic compound B represented by the general formula (3) and the group 2 element inorganic compound represented by the general formula (4), an organic solvent containing at least one compound selected from the group consisting of the group 13 element organic compound represented by the general formula (5) and the group 13 element inorganic compound represented by the general formula (6) and water independently or altogether to partially hydrolyse the organic zinc compound and at least partially hydrolyse the group 2 element organic compound A, the group 2 element organic compound B and the group 13 element organic compound, thereby obtaining the composition containing hydrolysates (including partial hydrolysates) dissolved in the organic solvent.

The step may also be the step of adding, to an organic solvent containing the organic zinc compound and at least one compound selected from the group 13 element organic compound represented by the general formula (5) and the group 13 element compound represented by the general formula (6) dissolved therein, an organic solvent containing at least one compound selected from the group 2 element organic compound A represented by the general formula (2), the group 2 element organic compound B represented by the general formula (3) and the group 2 element compound represented by the general formula (4) dissolved therein and water independently or altogether to obtain the composition containing a mixture of a hydrolysate obtained by at least partially hydrolysing at least one compound selected from the group 2 element organic compound A, the group 2 element organic compound B and the group 13 element organic compound and a partial hydrolysis of the organic zinc compound.

Again, in the step [4], there is a tendency that hydrolysis of the group 2 element organic compounds A and B and the group 13 element organic compound proceeds with priority to hydrolysis of the organic zinc compound. However, the tendency may change according to the manner of addition of solutions, stirring of the solutions or the manner and condition of addition of water. As a result, a mixture of a partial hydrolysate of the organic zinc compound and hydrolysates obtained by at least partially hydrolysing the group 2 element organic compound A, the group 2 element organic compound B and the group 13 element organic compound is obtained. The amount of water added may be in the range of a molar ratio of equal to or more than 0.05 to equal to or less than 0.8 relative to the total number of moles of the compounds (wherein the group 2 element inorganic compound represented by the general formula (4) and the group 13 element inorganic compound represented by the general formula (6) are excluded). The amount of water added may be preferably in the range of a molar ratio of 0.3 to 0.75 inclusive and still more preferably in the range of 0.4 to 0.7 inclusive relative to the total number of moles of the compounds.

In step [5], water is added to an organic solvent containing the organic zinc compound represented by the general formula (1) to obtain a partial hydrolysate of the organic zinc compound. The amount of water added may be in the range of a molar ratio of equal to or more than 0.05 to equal to or less than 0.8 relative to the organic zinc compound. The amount of water added may be preferably in the range of a molar ratio of 0.3 to 0.75 inclusive and still more preferably in the range of 0.4 to 0.7 inclusive relative to the organic zinc compound. To the obtained organic solvent containing the partial hydrolysate of the organic zinc compound, an organic solvent containing at least one compound selected from the group consisting of the group 2 element organic compound A represented by the general formula (2), the group 2 element organic compound B represented by the general formula (3), the group 2 element inorganic compound represented by the general formula (4), a hydrolysate obtained by at least partially hydrolysing the group 2 element organic compound A and a hydrolysate obtained by at least partially hydrolysing the group 2 element organic compound B is then added to obtain the composition. The composition obtained in the step contains a partial hydrolysate of the organic zinc compound and at least one compound from the group 2 element organic compound A, the group 2 element organic compound B, the group 2 element inorganic compound, a hydrolysate obtained by at least partially hydrolysing the group 2 element organic compound A and a hydrolysate obtained by at least partially hydrolysing the group 2 element organic compound B. The amount of water added for at least partially hydrolysing each of the group 2 element organic compound A and the group 2 element organic compound B may be in the range of a molar ratio of equal to or more than 0.05 to equal to or less than 0.8, and the amount of water added for hydrolysing a mixture of the group 2 element organic compound A and the group 2 element organic compound B may be in the range of a molar ratio of equal to or more than 0.05 to equal to or less than 0.8 relative to the total number of moles of the compounds. The amount of water added may respectively be preferably in the range of 0.3 to 0.75 inclusive and still more preferably in the range of 0.4 to 0.7 inclusive.

In step [6], water is added to an organic solvent containing the organic zinc compound represented by the general formula (1) to obtain a partial hydrolysate of the organic zinc compound. The amount of water added may be in the range of a molar ratio of equal to or more than 0.05 to equal to or less than 0.8 relative to the organic zinc compound. The amount of water added may be preferably in the range of a molar ratio of 0.3 to 0.75 inclusive and still more preferably 0.4 to 0.7 inclusive relative to the organic zinc compound. To the obtained organic solvent containing the partial hydrolysate of the organic zinc compound, an organic solvent containing at least one compound selected from the group consisting of the group 2 element organic compound A represented by the general formula (2), the group 2 element organic compound B represented by the general formula (3), the group 2 element inorganic compound represented by the general formula (4), a hydrolysate obtained by at least partially hydrolysing the group 2 element organic compound A and a hydrolysate obtained by at least partially hydrolysing the group 2 element organic compound B and at least one compound selected from the group consisting of the group 13 element organic compound represented by the general formula (5), a hydrolysate obtained by at least partially hydrolysing the group 13 element organic compound and the group 13 element inorganic compound represented by the general formula (6) is then added to obtain the composition. The composition obtained in the step contains a partial hydrolysate of the organic zinc compound and at least one compound from the group 2 element organic compound A, the group 2 element organic compound B, the group 2 element inorganic compound, a hydrolysate obtained by at least partially hydrolysing the group 2 element organic compound A and a hydrolysate obtained by at least partially hydrolysing the group 2 element organic compound B and at least one compound selected from the group consisting of the group 13 element organic compound, a hydrolysate obtained by at least partially hydrolysing the group 13 element organic compound and the group 13 element inorganic compound. The amount of water added for at least partially hydrolysing each of the group 2 element organic compound A and the group 2 element organic compound B may respectively be in the range of a molar ratio of equal to or more than 0.05 to equal to or less than 0.8, and the amount of water added for hydrolysing a mixture of the group 2 element organic compound A, the group 2 element organic compound B and the group 13 element organic compound may be in the range of a molar ratio of equal to or more than 0.05 to equal to or less than 0.8 relative to the total number of moles of the compounds. The amount of water added may respectively be preferably in the range of 0.3 to 0.75 inclusive and still more preferably in the range of 0.4 to 0.7 inclusive. The amount of water added for at least partially hydrolysing only the group 13 element organic compound may be in the range of a molar ratio of 0.05 to 1.3 inclusive, preferably 0.3 to 1.25 inclusive and still more preferably 0.4 to 1.2 inclusive relative to the compound.

In the steps [2] and [3], a preferable embodiment is the one in which water is added in the range of a molar ratio of equal to or more than 0.05 to equal to or less than 0.8 relative to the total number of moles of the compounds, i.e. the organic zinc compound represented by the general formula (1), the group 2 element organic compound A represented by the general formula (2) and the group 2 element organic compound B represented by the general formula (3) to partially hydrolyse the organic zinc compound and at least partially hydrolyse the group 2 element organic compound A and the group 2 element organic compound B.

In the step [4], a preferable embodiment is the one in which water is added in the range of a molar ratio of equal to or more than 0.05 to equal to or less than 0.8 relative to the total number of moles of the compounds, i.e. the organic zinc compound represented by the general formula (1), the group 2 element organic compound A represented by the general formula (2), the group 2 element organic compound B represented by the general formula (3) and the group 13 element organic compound represented by the general formula (5) to partially hydrolyse the organic zinc compound and at least partially hydrolyse the group 2 element organic compound A, the group 2 element organic compound B and the group 13 element organic compound.

The following Description is Common for the Above Steps [1] to [6].

Water may be added without mixing water with another solvent or after mixing water with another solvent. Water may be added over a period of, for example, 60 seconds to 10 hours, although the period depends on the scale of the reaction. Because the yield of the product is good, it is preferable to add water dropwise to a starting material, the organic zinc compound of the general formula (1). Water may be added while stirring a solution of the compound represented by the general formula (1) and the electron donating organic solvent. The temperature during addition may be any temperature between −90° C. and 150° C. The temperature is preferably −15° C. to 30° C. in view of reactivity of water with the organic zinc compound, the group 2 element organic compound A, the group 2 element organic compound B and the group 13 element organic compound.

After addition of water, stirring is implemented, for example, between 1 minute and 48 hours in order to proceed reaction between water and each of the organic zinc compound, the group 2 element organic compound A, the group 2 element organic compound B and the group 13 element organic compound. The reaction temperature may be any temperature between −90° C. and 150° C. The temperature is preferably 5° C. to 80° C. because the partial hydrolysate can be obtained at a high yield. The reaction pressure is not limited. Generally, the reaction may be carried out at normal pressure (atmospheric pressure). The reaction of water with the compound represented by the general formula (1) may be optionally monitored by sampling the reaction mixture and analysing the sample by NMR, IR and the like or by sampling the generated gas.

The organic solvent, a starting material, i.e. the organic zinc compound, the group 2 element organic compound A, the group 2 element organic compound B, the group 2 element inorganic compound, the group 13 element organic compound, the group 13 element inorganic compound and water may be introduced into a reactor according to any conventional manner and may be introduced as a mixture with a solvent. The reaction steps may be in any of batch operation, semi-batch operation and continuous operation without particular limitation. The reaction steps are preferably in batch operation.

By the reaction, the organic zinc compound of the general formula (1) and the group 2 element organic compound of the general formula (2), or the organic zinc compound of the general formula (1) or the group 2 element organic compound of the general formula (2) is partially hydrolysed by water to give a product containing a partial hydrolysate. When the organic zinc compound of the general formula (1) is diethylzinc, the product obtained by reaction with water has been conventionally analysed; however, different reports give different results and thus composition of the product is not necessarily defined. Composition of the product may vary according to the molar ratio of water added, the reaction time and the like. In the present invention, the main component of the product is, for the partial hydrolysate 2, a compound containing structural units represented by the following general formulae (7) and (8) and structural units represented by the following general formulae (9) and (10), or a mixture of various kinds of compounds in which m varies.

(R¹—Zn)— (7)

—[O—Zn]ₘ— (8)

(wherein R¹ is the same as R¹ in the general formula (1); and m is an integer of 1 to 20.)

(R²-M)- (9)

—[O-M]ₘ- (10)

(wherein M and R² are the same as M and R² in the general formula (2); and m is an integer of 1 to 20.)

Further, by hydrolysing the group 13 element organic compound represented by the general formula (5) with water, a product is obtained which contains a partial hydrolysate having structural units represented by the following general formulae (11) and (12), while by partially hydrolysing with water when the group 13 element organic compound represented by the general formula (5) co-exists with the organic zinc compound of the general formula (1) and the group 2 element organic compound of the general formula (2), a compound is obtained in which structural units of the above general formulae (7), (8), (9) and (10) and the structural units of the following general formulae (11) and (12) are arbitrarily combined.

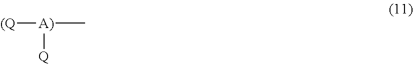

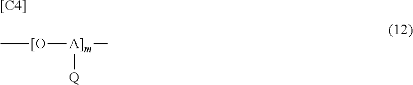

(wherein A is the same as A in the general formula (5); Q is the same as any of R⁴, R⁵ and R⁶ in the general formula (5); and m is an integer of 1 to 20.)

It is believed that the partial hydrolysate in the composition for producing a zinc oxide thin film containing a group 2 element of the present invention is, for example, a mixture of the compounds represented by the following general formulae (13) to (15) or a mixture of a plurality of compounds in which the above m varies.

R¹—Zn—[O—Zn]ₚ—R¹ (13)

(wherein R¹ is the same as R¹ in the general formula (1); and p is an integer of 1 to 20).

R²-M-[O-M]ₚ—R² (14)

(wherein M and R² are the same as M and R² in the general formula (2); and p is an integer of 1 to 20).

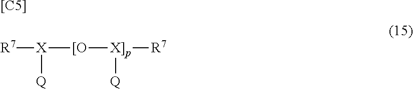

(wherein X is any of Zn in the general formula (1), M in the general formula (2) and A in the general formula (5); R⁷ is any of R¹ in the general formula (1) and R² in the general formula (2); Q is present only when X is A in the general formula (5) and the same as any of R⁴, R⁵ and R⁶ in the general formula (5) or

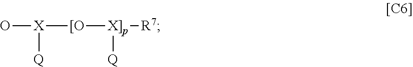

and p is an integer of 1 to 20).

Particularly, it is preferable that the partial hydrolysate in the composition for producing a zinc oxide thin film containing a group 2 element of the present invention essentially contains Zn and a group 2 element and has a structural example of the general formula (15) which includes a compound containing any various kinds of the above structural units of the general formulae (7) to (12). It is also desirable to carry out the method for preparing the composition of the present invention as described above so as to intend to form the compound containing a plurality of the structural units such as iii), Vii) and Viii). Particularly, it is intended that the partial hydrolysate in the composition of the present invention has at least the structural unit —Zn—O-M-.

Particularly, it is believed that, in the partial hydrolysate of the organic zinc compound of the present invention which is obtained by adding water while the organic zinc compound and the group 2 element organic compound A, the group 2 element organic compound B and/or the group 13 element organic compound co-exist such as those produced by the methods of the steps [1] to [4], a hydrolysate(s) of the group 2 element organic compound A, the group 2 element organic compound B and/or the group 13 element organic compound exists as a hydrolysate incorporated in the structure of the partial hydrolysate of the organic zinc compound as shown in the general formula (15), and hydrolysates of the group 2 element organic compound A, the group 2 element organic compound B and the group 13 element organic compound are obtained as, according to the condition of hydrolysis, a compound in which a partial hydrolysate which has remained side chains such as R⁷ and Q in the general formula (15) or a hydrolysate without the side chains due to complete hydrolysis and the partial hydrolysate of the organic zinc compound are integrated.

In preparation of the composition for producing a zinc oxide thin film containing a group 2 element of the present invention, the total number of moles of the compounds (including hydrolysates) containing a group 2 element, the group 2 element organic compound A, the group 2 element organic compound B and the group 2 element inorganic compound may be 0.001 to 4 and preferably 0.001 to 0.5 relative to the number of moles of the organic zinc compound (including a partial hydrolysate).

In preparation of the composition for producing a zinc oxide thin film containing a group 2 element of the present invention, the total number of moles of the group 13 element organic compound and the group 13 element inorganic compound (including hydrolysates) may be 0.000001 to 0.5 and preferably 0.00001 to 0.1 relative to the organic zinc compound (including a partial hydrolysate).

The solid content concentration of the composition for formation of a zinc oxide thin film containing a group 2 element may be arbitrarily selected from the range of 0.1 mass % to 30 mass % as the total concentration of a partial hydrolysate of the organic zinc compound, one or both of a partial hydrolysate of a partial hydrolysate of the group 2 element organic compound A and a partial hydrolysate of the group 2 element organic compound B and a partial hydrolysate of the group 13 element organic compound. The higher the concentration is, the fewer the number of applications required for production of a thin film are; however, taking the solubility of a reaction product containing a partial hydrolysate of the organic zinc compound, for example easiness of formation of the zinc oxide thin film containing a group 2 element into account, the concentration is preferably 0.1 mass % to 12 mass % and still more preferably 0.1 mass % to 6 mass % .

After hydrolysis reaction, a part of or whole product as described above may be recovered and purified by general methods such as filtration, concentration, extraction and column chromatography.

The composition separated and recovered from the organic solvent by the above methods may be dissolved in an organic solvent for film formation which is different from the organic solvent used for the reaction to give a solution for coating.

Examples of the solvent that may be used as the organic solvent for thin film formation include a C₅₋₂₀ more preferably C₆₋₁₂, linear or branched hydrocarbon compound or cyclic hydrocarbon compound, a C₆₋₂₀, more preferably C₆₋₁₂, aromatic hydrocarbon compound and a mixture thereof.

Specific examples of the hydrocarbon compound include an aliphatic hydrocarbon such as pentane, n-hexane, heptane, isohexane, methylpentane, octane, 2,2,4-trimethylpentane (isooctane), n-nonane, n-decane, n-hexadecane, octadecane, eicosane, methylheptane, 2,2-dimethylhexane and 2-methyloctane; an alicyclic hydrocarbon such as cyclopentane, cyclohexane methylcyclohexane and ethylcyclohexane; an aromatic hydrocarbon such as benzene, toluene, xylene, cumene and trimethylbenzene; and a hydrocarbon solvent such as mineral spirit, solvent naphtha, kerosene and petroleum ether.

Other examples that may be used as the organic solvent for thin film formation include an ether solvent such as 1,2-diethoxyethane, 1,2-dibutoxyethane, diethyl ether, di-n-propyl ether, di-isopropyl ether, dibutyl ether, tetrahydrofuran, dioxane, glyme, diglyme, triglyme, anisole and methoxytoluene, an amine solvent such as trimethylamine, triethylamine and triphenylamine and the like.

The solvents may not only be used solely but also be used in combination of two or more. The reaction product mixture may be used as a solution for coating without separating the organic solvent or after appropriately adjusting the concentration.

[Method for Producing a Zinc Oxide Thin Film Containing a Group 2 Element]

By using the composition for formation of a zinc oxide thin film containing a group 2 element of the present invention, a zinc oxide thin film containing a group 2 element may be produced. The production method specifically includes applying the composition for formation of a zinc oxide thin film containing a group 2 element of the present invention onto the surface of a substrate and then heating the obtained coating film to form a zinc oxide thin film containing a group 2 element.

The method for producing a zinc oxide thin film containing a group 2 element using the composition of the present invention includes applying the composition onto the surface of a substrate and then heating the obtained coating film to form a zinc oxide thin film containing a group 2 element. More specifically, the production method of the present invention includes carrying out at least once a process of applying the composition onto the surface of a substrate in an inert gas atmosphere and then heating the obtained coating article. The process of application and heating of the obtained coating article may be appropriately repeated for the number of times required for obtaining a desired property such as conductive property; the process may be appropriately repeated preferably 1 to 50 times, more preferably 1 to 30 times and still more preferably 1 to 10 times.

Application onto the surface of a substrate may be carried out by conventional manner such as spray coating, dip coating, spin coating, slit coating, slot coating, bar coating, roll coating, curtain coating, spray pyrolysis, electrostatic coating, ink jet and screen printing. Spray pyrolysis and electrostatic coating allow simultaneous application and film formation while heating the substrate. Therefore, a solvent can be dried concurrently with application and heating for drying the solvent may not be required according to the condition. Further, according to the condition, the reaction of a partial hydrolysate of the organic zinc compound, the group 2 element organic compound or the group 13 element organic compound to zinc oxide containing a group 2 element may proceed at least partially in addition to drying. Therefore, the following step of formation of an oxide thin film by heating at a predetermined temperature may be readily carried out. The temperature of heating of a substrate during application and film formation in spray pyrolysis may be in the range of, for example, 20° C. to 400° C. and preferably 50° C. to 400° C. When, particularly, the substrate of, for example, a resin having low heat resistance is used, heating may be carried out at 20° C. to 350° C. or, for those having further low heat resistance, 20° C. to 250° C.

Application of the composition onto the surface of a substrate may be carried out in any atmosphere such as an inert gas atmosphere such as nitrogen, an air atmosphere, an air atmosphere having high relative humidity with high amount of moisture, an oxidation gas atmosphere such as oxygen, a reducing gas atmosphere such as hydrogen and an atmosphere of mixed gas thereof under atmospheric pressure or increased pressure. The product contained in the composition of the present invention gradually decomposes by reacting with moisture in an atmosphere, and thus it is preferable that application is carried out in an inert gas atmosphere. Application in the method of the present invention may be carried out under reduced pressure; however, it is preferable to carry out the application at atmospheric pressure because this requires a simpler facility, minimizing cost expenditure.

In a procedure or situation where it is difficult to form zinc oxide containing a group 2 element by reaction with an oxygen source co-existing with the composition for formation of a zinc oxide thin film containing a group 2 element during or after application of the composition for formation of a zinc oxide thin film containing a group 2 element onto a substrate, as implemented by spray coating, dip coating, spin coating, slit coating, slot coating, bar coating, roll coating, curtain coating, electrostatic coating, ink jet and screen printing, a film may be formed in an atmosphere which contains substantially no or a little moisture during application and film formation. As it is difficult to completely eliminate moisture from a film formation atmosphere, the condition where the molar ratio is 0, namely the film formation atmosphere that does not contain moisture, means the moisture in the film formation atmosphere is 0.01 to 1000 ppm and preferably 0.1 to 400 ppm which is attainable by use of, generally, an inert gas.

In the present invention, it is also possible to form a film in an atmosphere where water is present by, for example, using spray coating which allows easier formation of a zinc oxide thin film containing a group 2 element by reaction with an oxygen source such as water that is allowed to co-exist with the composition for formation of a zinc oxide thin film containing a group 2 element in the space where the composition for formation of a zinc oxide thin film containing a group 2 element reaches a substrate by application such as in spray coating, spray pyrolysis, electrostatic coating and ink jet. The “atmosphere where water is present” in spray coating of a substrate may be, for example, an air atmosphere containing water at relative humidity of 10 to 95%. Instead of an air atmosphere, application may be carried out in an atmosphere of a gas mixture of water with an inert gas atmosphere such as nitrogen. The relative humidity is more preferably 30 to 90% because production of the zinc oxide thin film containing a group 2 element is smooth.

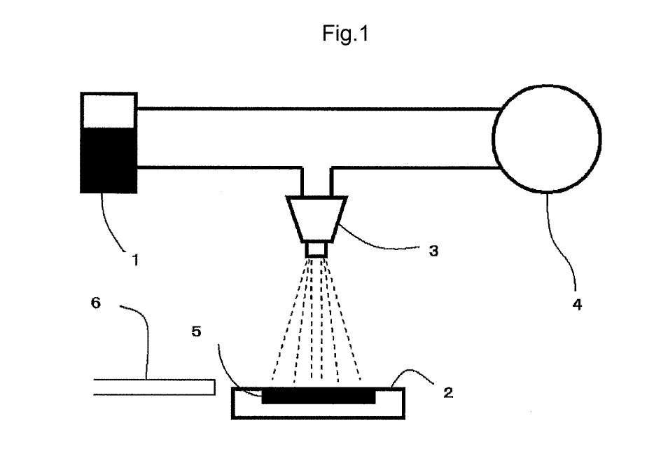

FIG. 1 shows a spray film formation device, an exemplary film formation device by spraying coating which can be used in the present invention. In FIG. 1, 1 is a spray bottle in which a coating solution is filled, 2 is a substrate holder, 3 is a spray nozzle, 4 is a compressor, 5 is a substrate and 6 is a water vapour introducing tube. Spray coating is carried out as follows: a substrate is placed on substrate holder 2 and optionally heated to a predetermined temperature with a heater followed by simultaneous supply of compressed inert gas and a coating solution from spray nozzle 3 disposed above the substrate in the atmosphere (under atmospheric pressure, in air) to atomize and spray the coating solution, water is introduced through water vapour introducing tube 6 so that water co-exists in the atmosphere for film formation to form a zinc oxide thin film containing a group 2 element on the substrate. The zinc oxide thin film containing a group 2 element is formed by spray coating without additional heating or the like.

Spray coating of a coating solution is preferably discharged from a spray nozzle such that a droplet of the coating solution is in the range of 30 μm or less by taking adhesion to a substrate, easy evaporation of a solvent and the like into account. Given, for instance, that some solvent evaporates and the size of droplets decreases while the coating solution reaches from a spray nozzle to a substrate, it is preferable to carry out spray coating with the distance between the spray nozzle and the substrate of 50 cm or less, in view of production of a zinc oxide thin film containing a group 2 element having preferable transparency.

Further, a transparent zinc oxide thin film containing a group 2 element can be formed on a substrate only by simultaneously supplying compressed inert gas and a coating solution from spray nozzle 3 disposed above the substrate and atomizing and spraying the coating solution without heating the substrate and the atmosphere.

Any of the applications in the method of the present invention may be carried out under increased or reduced pressure; however, carrying out the application at atmospheric pressure is preferable because this requires simpler facility, minimizing cost expenditure.

After application of the coating solution onto the surface of a substrate, the substrate is optionally brought to a predetermined temperature to dry the solvent and then heated to a predetermined temperature to form a zinc oxide thin film containing a group 2 element.

The condition for drying a solvent may be appropriately set according to the type of the co-existing organic solvent and the boiling point (vapour pressure). The temperature for drying a solvent may be in the range of, for example, 20° C. to 350° C. and when the solvent has a boiling point of 200° C. or lower, the temperature for drying may be 20° C. to 250° C. and when the solvent has a boiling point of 150° C. or less, the temperature may be 20° C. to 200° C. The time for drying may be generally 0.2 to 300 minutes and preferably 0.5 to 120 minutes.

In the present invention, the heating temperature for formation of a zinc oxide thin film containing a group 2 element after drying a solvent is, for example, in the range of 20° C. to 800° C. and preferably in the range of 30° C. to 800° C. It is characterised in that the process at the temperature is carried out at least once. The heating time at the heating temperature is generally 0.2 to 300 minutes and preferably 0.5 to 120 minutes. The zinc oxide thin film containing a group 2 element of the present invention formed by heating at 400° C. or lower is generally amorphous. Meanwhile crystallisation may be carried out by heat treatment at a heating temperature and in a process atmosphere where a zinc oxide thin film containing a group 2 element crystallises such as at 500° C. or higher.

By carrying out drying of a solvent and heating thereafter for formation of zinc oxide containing a group 2 element at the same temperature, it is possible to simultaneously dry solvent and form zinc oxide containing a group 2 element.

Optionally, heating described above may further be carried out in an oxidation gas atmosphere such as oxygen, in a reducing gas atmosphere such as hydrogen or in a plasma atmosphere such as hydrogen, argon or oxygen to promote formation of zinc oxide containing a group 2 element or improve crystallinity. Light irradiation may also promote formation of zinc oxide containing a group 2 element or improve crystallinity. The light irradiation may be carried out by well-known methods which are generally known. Specifically, any light source such as a mercury lamp, a deuterium lamp, rare gas-discharge light, various lasers may be used. The wavelength of the light source is not particularly limited; however, the wavelength used is preferably 170 nm to 600 nm and more preferably 170 to 400 nm. The heating and light irradiation described above may be carried out respectively alone or in combination.

The film thickness of zinc oxide containing a group 2 element is not particularly limited; however, the film thickness may be practically in the range of 0.001 to 5 μm and generally 0.01 to 5 μm. According to the production method of the present invention, by carrying out the application (drying)/heating at least once, the film having the thickness described above can be appropriately produced. In principle, a film having a thickness of 5 μm or more may be formed by repeating application or extending the application time.

Drying a solvent, heating and light irradiation in any methods which can be used in the present invention may be carried out under increased or reduced pressure; however, carrying out the above operation at atmospheric pressure is preferable because this requires a simpler facility, minimizing cost expenditure.

In the production method, the substrate for formation of a zinc oxide thin film containing a group 2 element may be an inorganic substance such as glass, metal and ceramics; an organic substance such as a polymer substrate including plastics, paper and wood; and a composite material thereof.

The substrate is not particularly limited so long as the substrate does not affect formation of the zinc oxide thin film containing a group 2 element. Examples of glass include quartz glass, borosilicate glass, soda glass, alkali-free glass and lead glass and oxides of sapphire and the like. Examples of metal include stainless steel such as SUS304 and SUS316, aluminium, iron, copper, titanium, silicon, nickel, gold, silver and an alloy containing the foregoing. Examples of ceramics include an oxide such as alumina, silica, zirconia and titania; a nitride such as boron nitride, aluminium nitride, silicon nitride, titanium nitride and gallium nitride; a carbon compound such as silicon carbide and a composite containing the foregoing. Examples of the polymer forming plastics include polyester (such as polyethylene terephthalate (PET), polyethylene naphthalate (PEN), poly(meth)acryl (such as poly(methyl methacrylate) (PMMA)), polycarbonate (PC), polyphenylene sulphide (PPS), polystyrene, polyvinyl alcohol (PVA), polyvinyl chloride (PVC), polyvinylidene chloride, polyethylene (PE), polypropylene (PP), a cyclic olefin polymer (COP), an ethylene-vinyl acetate copolymer (EVA), polyimide, polyamide, polyaramide, polyether sulfone (PES), polyurethane, triacetate, triacetyl cellulose (TAC), Cellophane fluororesin (such as polytetrafluoroethylene (PTFE), polychlorotrifluoroethylene (PCTFE), polyvinylidene fluoride (PVDF), polyvinyl fluoride (PVF) perfluoroalkoxy fluororesin (PFA), a tetrafluoroethylene-hexafluoropropylene copolymer (FEP), an ethylene-tetrafluoroethylene copolymer (ETFE), an ethylene-chlorotrifluoroethylene copolymer (ECTFE)) and a composite resin containing the foregoing. Among these, EVA, COP, PP, PE, PET, PPS, PEN, PC, PMMA, PES, polyimide, polyamide, aramide, PVC and PVA are preferred.

Examples of the shape of the substrate which can be used include a film shape, a plate shape, a steric structure with any three-dimensional shape and an article with a shape combining the foregoing.

The substrate may be any of transparent, semi-transparent and non-transparent.

For example, examples of a film-shaped transparent substrate include an inorganic article such as a glass thin plate and an organic article such as a plastic film serving as a polymer substrate.

The substrate which is a plastic film may be a non-stretched film or a stretched film according to the type of the polymer. For example, a polyester film, for example, a PET film is usually a biaxial stretched film and a PC film, a triacetate film, a Cellophane film and the like are usually non-stretched films.

Examples of a non-transparent instrument which may be used include a wafer and sheet of a metal, a metal oxide, a nitride, a carbon compound and the like and a polymer substrate of polyimide, polyamide, aramide, carbon fibres, PP, PE or PET sheet, non-woven cloth and the like.

In addition to the above substrates, a film can be formed by application onto a functional material such as an electrode, a semiconductor, an electronic device film such as an insulating material formed with an inorganic material including a metal, an oxide, a nitride, a carbon compound and the like, low-molecular, polymer or other type organic materials and a composite of the inorganic and organic materials described above.

### EXAMPLES

The present invention is further described in detail based on Examples. Examples exemplify the present invention and it is not intended that the present invention is limited by Examples.

Reagents used in Example were commercially available. Preparation of all products including partial hydrolysates from organic zinc compounds and film formation using the same were carried out in a nitrogen gas atmosphere and all solvents were used after dehydration and degassing.

The content of metal such as Zn, Mg and Al in each composition was measured by ICP-AES (inductively coupled plasma atomic emission spectroscopy) using a solution obtained by hydrolysis of the composition.

### Example 1

At room temperature, 1.17 g of water and 56.6 g of tetrahydrofuran were mixed to prepare a mixed solution (total: 57.77 g (hereinafter referred to as solution A)). Separately, 4.0 g of dibutylmagnesium (1 mol/L heptane solution (containing triethylaluminium (1 wt % or less)), manufactured by Sigma-Aldrich Co, LLC.) and 50.0 g of 1,2-diethoxyethane were mixed at room temperature to prepare a mixed solution (total: 54.0 g (hereinafter referred to as solution B)).

To 120 g of 1,2-diethoxyethane was added 13.33 g of diethylzinc (manufactured by Tosoh Finechem Corporation) and thoroughly stirred followed by cooling to 2° C. To the diethylzinc/1,2-diethoxyethane solution (133.33 g (hereinafter referred to as solution C)), solution A and solution B were added dropwise over 30 minutes while stirring from different places by adjusting the dripping speed of the respective mixed solutions so that the dropwise addition of solution A and solution B completed at almost the same time. During the dropwise addition, the temperature of the mixture of solution C and solutions A and B was adjusted so as to be 1° C. to 2° C.

After completion of dropwise addition of each mixed solution, the obtained mixture was heated to room temperature (20° C.) and stirred continuously at room temperature (20° C. to 24° C.) for 18 hours. The product after completion of reaction was a yellow transparent solution which was clouded because of precipitation of a minute amount of insoluble matters. The product was filtered to remove the insoluble matters and recover a yellow transparent solution (composition 1).

### Example 2

A yellow transparent solution (composition 2) was recovered in the same manner as in Example 1 except that solution A used was a mixed solution (total: 54.67 g) obtained by mixing 1.17 g of water and 53.5 g of tetrahydrofuran at room temperature, solution B used was a mixed solution (total: 51.55 g) obtained by mixing 1.55 g of dibutylmagnesium (1 mol/L heptane solution (containing triethylaluminium (1 wt % or less)), manufactured by Sigma-Aldrich Co, LLC.) and 50.0 g of 1,2-diethoxyethane at room temperature, solution A and solution B were added dropwise to the diethylzinc/1,2-diethoxyethane solution over 44 minutes and the temperature of a mixture of solution C and solutions A and B during dropwise addition was 2° C. to 5° C.

### Example 3

A yellow transparent solution (composition 3) was recovered in the same manner as in Example 1 except that solution A used was a mixed solution (total: 61.07 g) obtained by mixing 1.17 g of water and 59.9 g of tetrahydrofuran at room temperature, solution B used was a mixed solution (total: 56.7 g) obtained by mixing 6.7 g of dibutylmagnesium (1 mol/L heptane solution (containing triethylaluminium (1 wt % or less)), manufactured by Sigma-Aldrich Co, LLC.) and 50.0 g of 1,2-diethoxyethane at room temperature, solution A and solution B were added dropwise to the diethylzinc/1,2-diethoxyethane solution over 50 minutes and the temperature of a mixture of solution C and solutions A and B during dropwise addition was 1° C. to 3° C.

### Example 4

A yellow transparent solution (composition 4) was recovered in the same manner as in Example 1 except that solution A used was a mixed solution (total: 59.17 g) obtained by mixing 1.17 g of water and 58.0 g of tetrahydrofuran at room temperature, solution B used was a mixed solution (total: 53.41 g) obtained by mixing 13.41 g of dibutylmagnesium (1 mol/L heptane solution (containing triethylaluminium (1 wt % or less)), manufactured by Sigma-Aldrich Co, LLC.) and 40.0 g of toluene at room temperature, solution A and solution B were added dropwise to the diethylzinc/1,2-diethoxyethane solution over 1 hour and 24 minutes and the temperature of a mixture of solution C and solutions A and B during dropwise addition was 0° C. to 3° C.

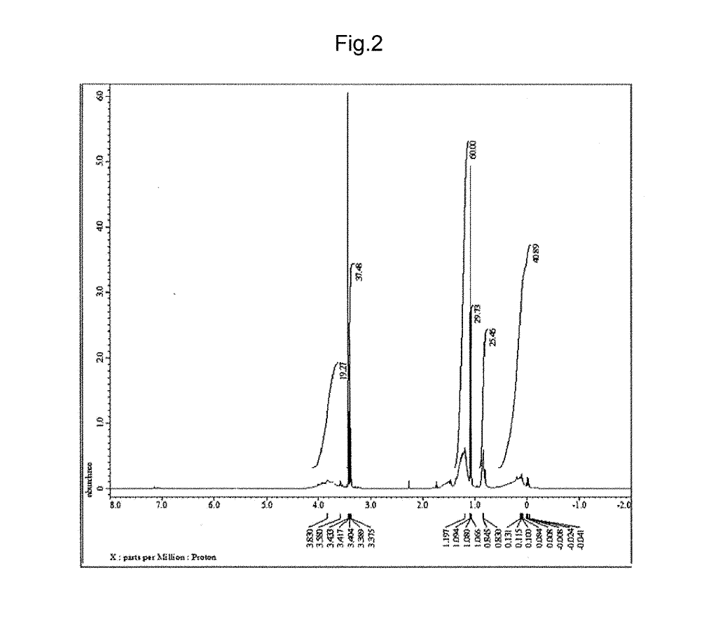

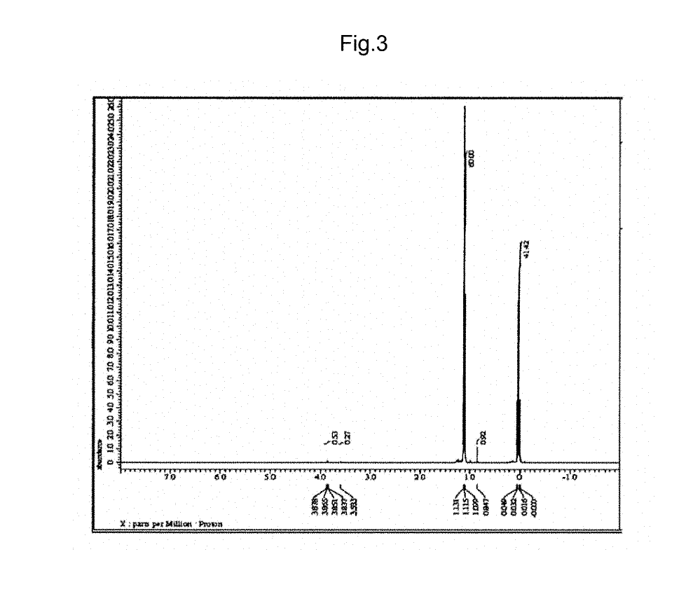

A part of the obtained solution was concentrated under reduced pressure by removing the solvent and a transparent liquid was obtained. The transparent liquid was subjected to ¹H-NMR (THF-d₈, ppm) to give the spectrum shown in FIG. 2. For comparison, the starting materials used for preparation of composition 4 of the present Example were subjected to measure a ¹H-NMR spectrum (THF-d₈, ppm). FIGS. 3 to 5 respectively show the ¹H-NMR spectrum of diethylzinc, the ¹H-NMR spectrum of dibutylmagnesium (1 mol/L heptane solution (containing triethylaluminium (1 wt % or less))) after concentration under reduced pressure and the ¹H-NMR spectrum of 1,2-diethoxyethane.

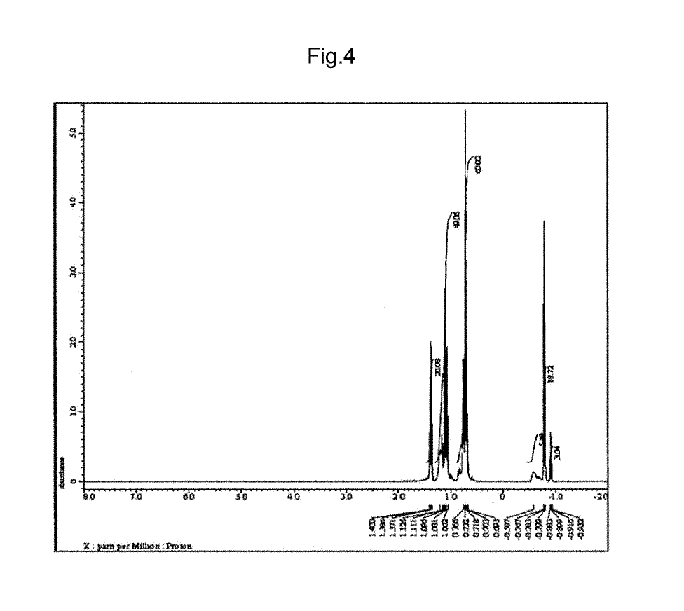

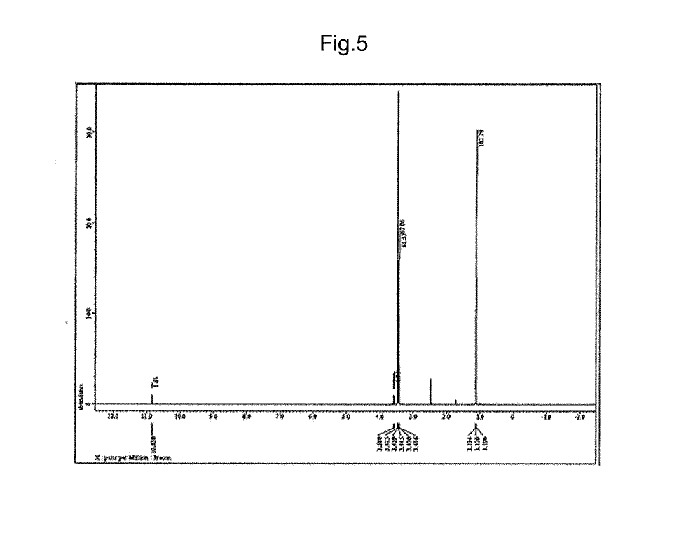

From the comparison of the ¹H-NMR spectra in FIG. 2 and FIGS. 3 to 5, it was found that in the spectrum in FIG. 2 of the compound obtained by concentrating composition 4, peaks derived from diethylzinc (δ 0.02 ppm (q), δ 1.11 ppm (t)) observed in FIG. 3 or peaks derived from the contents in the dibutylmagnesium solution (triethylaluminium: δ-0.9 ppm (q)), dibutylmagnesium: −0.78 ppm (t), δ0.72 (t), δ 1.09 ppm (m), δ 1.39 ppm (m)) observed in FIG. 4 were so small that assignment was difficult. Further, other than the peaks derived from diethylzinc and contents in the dibutylmagnesium solution, peaks were observed at δ 0 to 0.5 ppm (brs), δ 0.78 to 0.9 ppm (brs), δ 1.1 to 1.7 ppm (brs), δ 3.6 to 4.1 ppm (brs), (δ0.78 to 0.9 ppm (brs) and δ 1.1 to 1.7 ppm (brs) were also overlapped with residual heptane peaks). The peaks different from those of starting materials before partial hydrolysis are assigned to alkyl groups derived from the starting materials as side chains of partial hydrolysates of diethyizinc, dibutylmagnesium and triethylaluminium. In the present concentrate, residual peaks of 1,2-diethoxyethane (δ 1.1 ppm (t), δ 3.4. ppm (q) and δ 3.43 ppm (s)) were observed as shown in FIG. 5. When the concentrate was brought into contact with diluted nitric acid, hydrolysis gas was generated at a considerably higher amount than the amount of gas that would be generated by hydrolysis of diethyizinc, dibutylmagnesium and triethylaluminium (deduced from ¹H-NMR) remaining in the concentrate, and thus the result supported that the alkyl groups derived from the starting materials were present as side chains of partial hydrolysates of diethyizinc, dibutylmagnesium and triethylaluminium.

As described above, it was confirmed that the concentrate of composition 4 was soluble in an organic solvent, had low content of starting materials of diethyizinc, dibutylmagnesium and triethylaluminium and, from ¹H-NMR and gas analyses, contained compounds resulting from partial hydrolysis of diethylzinc and dibutylmagnesium. Namely, composition 4 prepared by the manner described in Example 4 contains compounds obtained by partial hydrolysis of diethylzinc and dibutylmagnesium.

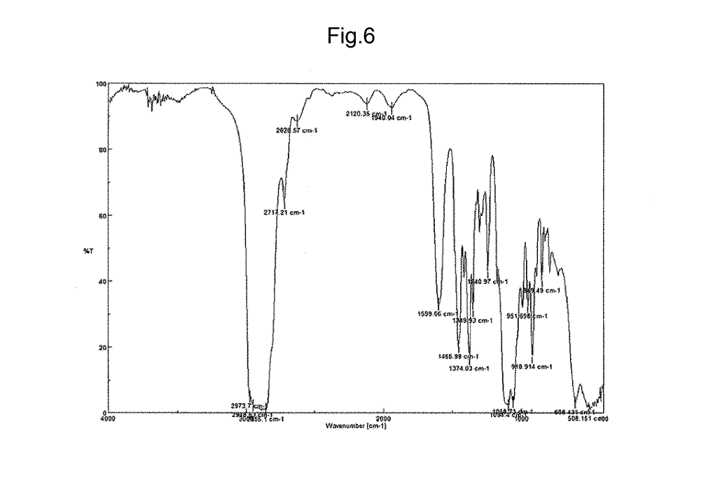

Further, the transparent liquid obtained by concentration under reduced pressure of composition 4 described above was subjected to FT-IR (a KBr cell, cm⁻¹) to obtain the spectrum in FIG. 6.

### Example 5

A yellow transparent solution (composition 5) was recovered in the same manner as in Example 1 except that solution A used was a mixed solution (total: 59.17 g) obtained by mixing 1.17 g of water and 58.0 g of tetrahydrofuran at room temperature, solution B used was a mixed solution (total: 51.34 g) obtained by mixing 25.34 g of dibutylmagnesium (1 mol/L heptane solution (containing triethylaluminium (1 wt % or less)), manufactured by Sigma-Aldrich Co, LLC.) and 26.0 g of toluene at room temperature, solution A and solution B were added dropwise to the diethylzinc/1,2-diethoxyethane solution over 1 hour and 23 minutes and the temperature of a mixture of solution C and solutions A and B during dropwise addition was 1° C. to 4° C.

The compositions obtained in Examples 2 to 5 were subjected to ICP-AES for measurement of contents (wt % ) of Zn, Mg and Al in the compositions to obtain the results shown in Table 1.

TABLE 1

| | Content of metal in composition (unit: wt %) | | | |
|---|---|---|---|---|
| | Example 2 | Example 3 | Example 4 | Example 5 |
| Metal in | Compo- | Compo- | Compo- | Compo- |
| composition | sition 2 | sition 3 | sition 4 | sition 5 |
| Zn | 3.0 | 3.1 | 2.9 | 3.0 |
| Mg | 0.02 | 0.10 | 0.19 | 0.36 |
| Al | 0.003 | 0.012 | 0.025 | 0.05 |

For the compositions obtained in Examples 2 to 5, the molar ratios of metal components in the solutions were calculated in percentage from the contents (wt % ) of Zn, Mg and Al to obtained the results shown in Table 2.

Molar ratio of Zn, Mg or Al=(Content of Zn, Mg or Al/Molecular weight of Zn, Mg or Al)

Molar ratio of the metal in the composition (converted to percentage: %)=(Molar ratio of Zn, Mg or Al/(Sum of the molar ratios of the metals))×100

TABLE 2

| | Molar ratio of metal in composition | | | |
|---|---|---|---|---|
| | (converted to percentage: %) | | | |
| | Example 2 | Example 3 | Example 4 | Example 5 |
| Metal in | Compo- | Compo- | Compo- | Compo- |
| composition | sition 2 | sition 3 | sition 4 | sition 5 |
| Zn | 98 | 91 | 83 | 73 |
| Mg | 1.8 | 8 | 15 | 24 |
| Al | 0.2 | 1 | 2 | 3 |

### Example 6

Water (2.35 g) and 53.34 g of tetrahydrofuran were mixed at room temperature to prepare a mixed solution (total: 55.69 g (hereinafter referred to as solution D)). Separately, 8.13 g of dibutylmagnesium (1 mol/L heptane solution (containing triethylaluminium (1 wt % or less)), manufactured by Sigma-Aldrich Co, LLC.), 0.69 g of triethylgallium and 100.06 g of toluene were mixed at room temperature to prepare a mixed solution (total: 108.88 g (hereinafter referred to as solution E)).

To 240.04 g of 1,2-diethoxyethane was added 26.71 g of diethylzinc (manufactured by Tosoh Finechem Corporation) and thoroughly stirred at room temperature followed by cooling to −2° C. To the diethylzind1,2-diethoxyethane solution (266.75 g: solution F), solution D and solution E were added dropwise over 2 hours and 30 minutes while stirring from different places by adjusting the dripping speed of the respective mixed solutions so that the dropwise addition of solution D and solution E completed at almost the same time. During the dropwise addition, the temperature of the mixture of solution D and solution E and solution F was adjusted so as to be 0° C. to −2° C.

After completion of dropwise addition of each mixed solution, the obtained mixture was heated to room temperature (23° C.) and stirred continuously at room temperature (20° C. to 24° C.) for 18 hours. The product after completion of reaction was a yellow transparent solution which was clouded because of precipitation of a minute amount of insoluble matters. The product was filtered to remove the insoluble matters and recover 406.00 g of yellow transparent solution (composition 6).

The obtained composition 6 was subjected to ICP-AES for measurement of contents of Zn, Mg, Ga and Al, and it was found that the contents were Zn: 3.4 wt % , Mg: 0.06 wt % , Ga: 0.06 wt % and Al: 0.008 wt % .

### Example 7

To 117.60 g of 1,2-diethoxyethane were added 15.0 g of diethylzinc (manufactured by Tosoh Finechem Corporation) and 4.15 g of dibutylmagnesium (1 mol/L heptane solution (containing triethylaluminium (1 wt % or less)), manufactured by Sigma-Aldrich Co, LLC.). After thorough stirring, the solution was cooled to −11° C. A mixed solution of 1.31 of water and 12.0 g of tetrahydrofuran was added dropwise while stirring so that the molar ratio of water relative to diethylzinc was 0.6. The mixture was then heated to room temperature (18° C.) and allowed to react at room temperature for 18 hours. The product after reaction was a yellow transparent solution which was slightly clouded because of insoluble matters. The product was filtered to recover 125.27 g of yellow transparent solution (composition 7).

Addition of 125.28 g of 1,2-diethoxyethane to 125.27 g of the yellow transparent solution resulted in a homogeneous solution and no precipitation or the like was observed in the obtained diluted solution (composition 8) in 1,2-diethoxyethane. As described above, the composition of the present invention allows dilution with an organic solvent, resulting in preparation of a solution having a decreased concentration of metal compared to the concentration before dilution.

### Example 8

In 225 g of 1,2-diethoxyethane was dissolved 25.0 g of diethylzinc (manufactured by Tosoh Finechem Corporation), thoroughly stirred and then cooled to −12° C. To the solution was added dropwise a mixture of 2.17 g of magnesium acetate tetrahydrate, 1.46 g of water and 16.89 g of tetrahydrofuran while stirring. The mixture was then heated to room temperature (31° C.) and allowed to react at room temperature (20° C. to 31° C.) for 18 hours. The product after reaction was a yellow transparent solution which was slightly clouded because of insoluble matters. The product was filtered to recover a yellow transparent solution (composition 9).

### Example 9

To 225 g of 1,2-diethoxyethane was dissolved 25.0 g of diethylzinc (manufactured by Tosoh Finechem Corporation), thoroughly stirred and then cooled to −12° C. To the solution was added dropwise a mixture of 2.17 g of magnesium nitrate hexahydrate, 1.09 g of water and 16.87 g of tetrahydrofuran while stirring. The mixture was then heated to room temperature (25° C.) and stirred continuously at room temperature (20° C. to 25° C.) for 18 hours. The product after reaction was a yellow transparent solution which was clouded because of precipitation of a minute amount of insoluble matters. The product was filtered to recover a yellow transparent solution (composition 10).

### Example 10

To composition 5 obtained in Example 5 were added dibutylmagnesium (1 mol/L heptane solution (containing triethylaluminium (1 wt % or less)), manufactured by Sigma-Aldrich Co, LLC.) and tetrahydrofuran at room temperature and thoroughly stirred to obtain homogeneous solutions, thereby preparing compositions in which the co-existing amount of Mg relative to Zn was high (the Mg/(Mg+Zn) molar ratio was high). All the obtained mixtures were transparent solutions without insoluble matters such as precipitations. The compositions (compositions 11 to 15) obtained by the procedure are shown in Table 3. As described above, the composition of the present invention may be prepared as a composition of an organic zinc compound containing Mg at a high level of concentration.

TABLE 3

| | | Example 10 | | | | |
|---|---|---|---|---|---|---|
| | | Compo- | Compo- | Compo- | Compo- | Compo- |
| Starting | | sition | sition | sition | sition | sition |
| material | Unit | 11 | 12 | 13 | 14 | 15 |
| Composition E | g | 2.00 | 2.00 | 2.00 | 2.00 | 2.00 |
| DBM | g | 0.22 | 0.43 | 0.75 | 1.28 | 2.53 |
| THF | g | 2.22 | 2.05 | 1.82 | 1.44 | 0.67 |
| Mg/(Mg + Zn) | mol/ | 0.4 | 0.5 | 0.6 | 0.7 | 0.8 |
| molar ratio | mol | | | | | |
| Mg/Zn | mol/ | 0.66 | 1.0 | 1.5 | 2.3 | 4 |
| molar ratio | mol | | | | | |

DBM: Dibutylmagnesium (1 mol/L heptane solution (containing triethylaluminium (1 wt % or less)), manufactured by Sigma-Aldrich Co, LLC.)
THF: Tetrahydrofuran

The molar ratios of water used for preparation of the compositions in Examples 1 to 9 relative to the metal are shown in the following Table 4.

TABLE 4

| | | Ex. | | | | | | | | |
|---|---|---|---|---|---|---|---|---|---|---|
| | | 1 | 2 | 3 | 4 | 5 | 6 | 7 | 8 | 9 |
| | | Comp. | | | | | | | | |
| | | 1 | 2 | 3 | 4 | 5 | 6 | 7 | 8 | 9 |
| H₂O/Zn | Molar | 0.60 | 0.60 | 0.60 | 0.60 | 0.60 | 0.60 | 0.60 | 0.60 | 0.55 |
| | ratio | | | | | | | | | |
| H₂O/(Zn + Mg) | Molar | 0.572 | 0.593 | 0.553 | 0.51 | 0.45 | 0.57 | 0.571 | 0.57 | 0.53 |
| | ratio | | | | | | | | | |
| H₂O/(Zn + Mg + Al) | Molar | 0.568 | 0.592 | 0.548 | 0.50 | 0.44 | | 0.568 | | |
| | ratio | | | | | | | | | |
| H₂O/(Zn + Mg + Al + Ga) | Molar | | | | | | 0.56 | | | |
| | ratio | | | | | | | | | |

Remarks: Calculated from the specific gravity of the dibutylmagnesium/heptane solution: 0.713 g/cc and Mg/Al=8 (molar ratio: measured value)

### Reference Example 1

In the following Reference Examples, zinc oxide thin films containing Mg on the substrates after respective film formation and formation of the films were confirmed by analyses by ATR-IR (infrared spectroscopy by attenuated total reflection (ATR)), EPMA (Electron Probe Micro Analyzer) and XRD (X-ray diffraction).

The transmission of visible light and the like was measured on a spectrophotometer.

Zinc oxide thin films containing Mg were measured on a stylus profilometer or on a scanning electron microscope (SEM) of the cross-section of the thin films.

Composition 4 obtained in Example 4 was applied on the surface of a square glass substrate (manufactured by Corning Incorporated, Eagle XG) with 25 mm on a side by spin coating. In a nitrogen atmosphere, 50 μl of the solution was dropped on the glass substrate which was then rotated for 20 seconds at a rotating speed of 1000 rpm to spread the solution throughout the glass substrate. After drying for 30 seconds, the substrate was heated at 200° C. for 2 minutes to dry the solvent and at the same time form zinc oxide containing Mg. By repeating the procedure for 3 times, thin film A was formed.

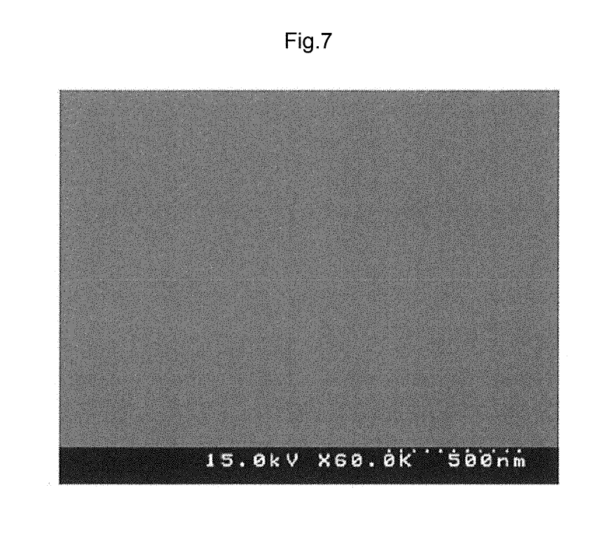

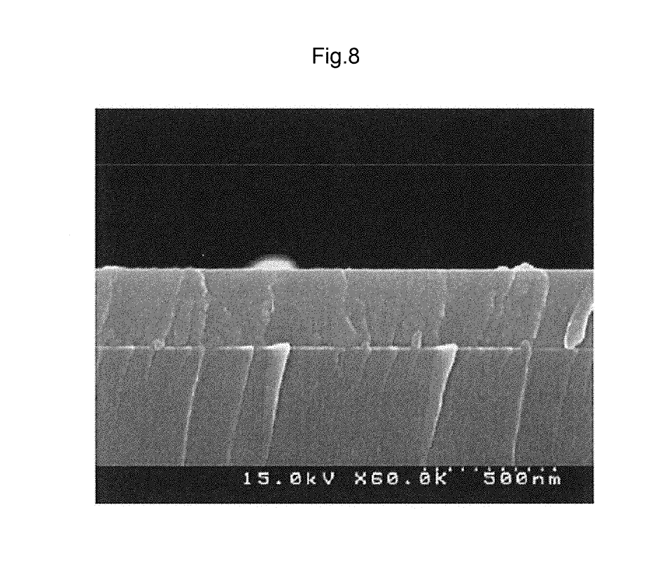

The obtained thin film A was analysed by ATR-IR to confirm that peaks derived from C—H in the structure of the organic zinc compound, the organic magnesium compound and the solvent were not observed between 2800 to 3100 cm⁻¹. When the formed thin film was observed on a SEM, it was found that the film was smooth without irregularity as shown in FIGS. 7 and 8 and the thin film had a thickness of 284 nm (an average film thickness per application: 94 nm). The thin film was further analysed by XRD and it was found that the oxide was amorphous. The transmission of visible light (550 nm) was 98.3%, and thus the transparent zinc oxide thin film containing Mg was obtained.

### Reference Example 2

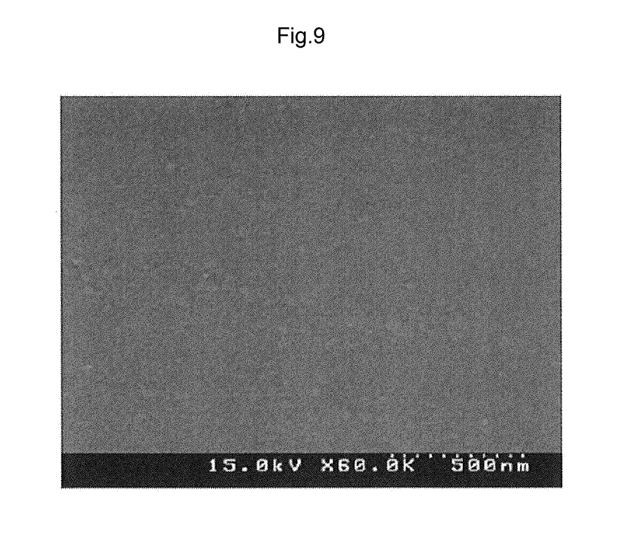

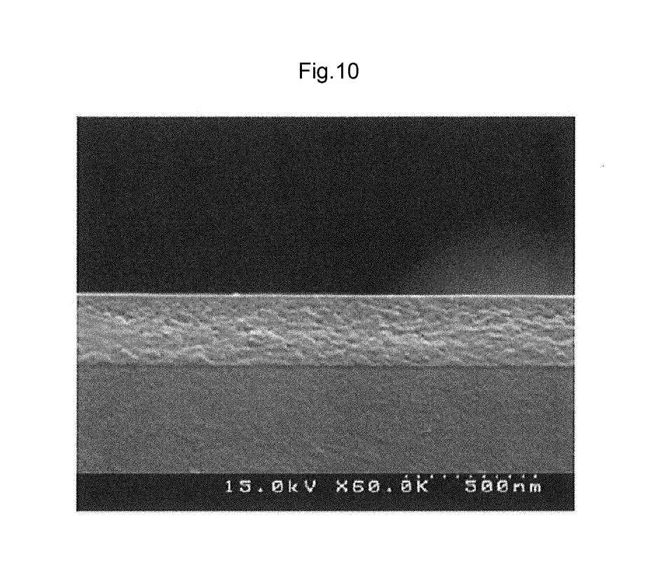

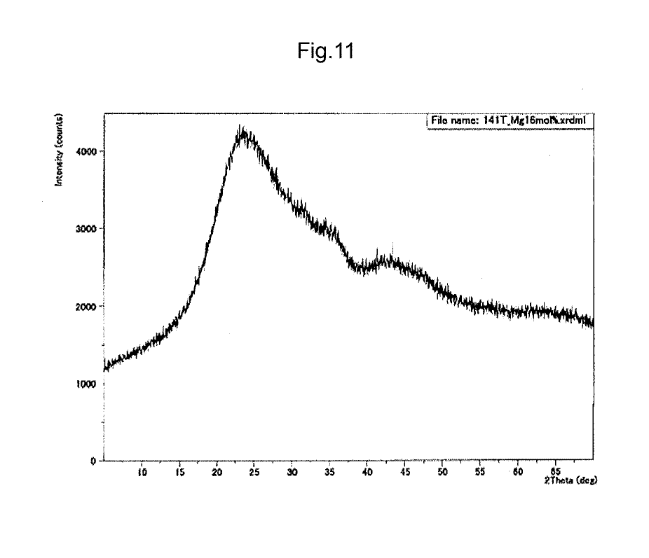

The same procedures and analyses were carried out as in Reference Example 1 except that the heating temperature after application of the solution was 500° C. It was confirmed from ATR-IR that peaks derived from C—H in the structure of the organic zinc compound, the organic magnesium compound and the solvent were not observed between 2800 to 3100 cm⁻¹. When the formed thin film was observed on a scanning electron microscope, it was found that the film was smooth without irregularity as shown in FIGS. 9 and 10 and the thin film had a thickness of 261 nm (an average film thickness per application: 87 nm). As a result of XRD, the peak as shown in FIG. 11 was obtained from which the thin film was found to be crystal. The transmission of visible light (550 nm) was 90.5%, and thus the transparent zinc oxide thin film containing Mg was obtained.

### Reference Examples 3 to 6

The same procedures and analyses were carried out as in Reference Example 1 except that one of compositions 2, 3 and 5 was used instead of composition 4. The obtained results are shown in Table 5.

TABLE 5

| | | Ref. Ex. 3 | Ref. Ex. 4 | Ref. Ex. 5 |
|---|---|---|---|---|
| Starting | | Compo- | Compo- | Compo- |
| material | Unit | sition 2 | sition 3 | sition 5 |
| Transmission of | % | 98.0 | 98.3 | 95.2 |
| visible light | | | | |
| (550 nm) | | | | |

### Reference Examples 6 to 9

The same procedures and analyses were carried out as in Reference Example 2 except that one of compositions 2, 3, 5 and 8 was used instead of composition 4. The obtained results are shown in Table 6.

TABLE 6

| | | Ref. Ex. 6 | Ref. Ex. 7 | Ref. Ex. 8 | Ref. Ex. 9 |
|---|---|---|---|---|---|
| Starting | | Compo- | Compo- | Compo- | Compo- |
| material | Unit | sition 2 | sition 3 | sition 5 | sition 8 |
| Transmission of | % | 81.0 | 84.2 | 88.0 | 79.0 |
| visible light | | | | | |
| (550 nm) | | | | | |

### Reference Example 10

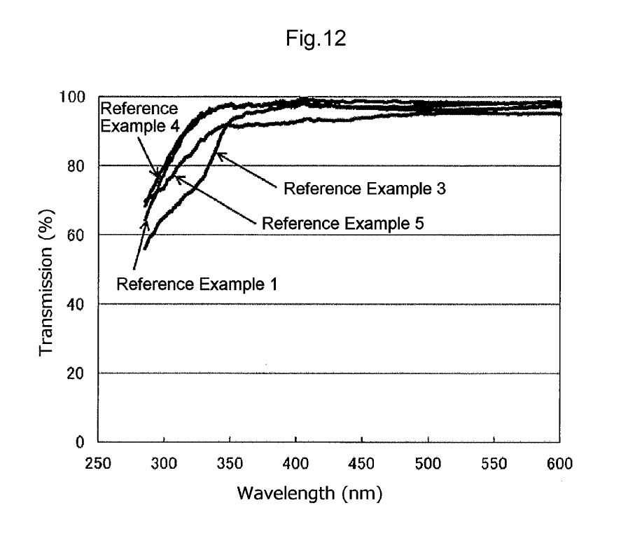

The decrease of absorption at or below 400 nm in the transmission of zinc oxide thin films containing a group 2 element obtained in Reference Example 1 and Reference Examples 3 to 5 was examined. FIG. 12 shows the transmission of the thin films at or below 600 nm. The drop of absorption shifted towards shorter wavelengths by increase of the Mg concentration, and it was found that in zinc oxide containing Mg obtained by using the present composition, a bandgap increase effect was exhibited by addition of Mg.

### Reference Example 11

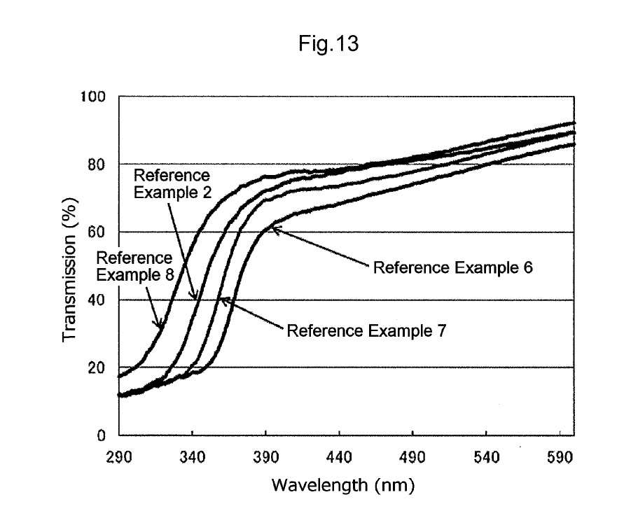

The transmission of zinc oxide thin films containing a group 2 element obtained in Reference Example 2 and Reference Examples 6 to 8 was measured and the decrease of absorption at or below 400 nm was examined. FIG. 13 shows the transmission of the thin films at or below 600 nm. The drop of absorption shifted towards shorter wavelengths when the Mg concentration was increased, and it was found that in zinc oxide containing Mg obtained by using the present composition, a bandgap increase effect was exhibited by addition of Mg.

### Reference Example 12

A zinc oxide thin film containing Mg was formed and analysed in the same manner as in Reference Example 1 except that in film formation using composition 5 in Reference Example 8, a polypropylene (PP) film (a square with 30 mm per side (thickness: 0.2 mm)) substrate was used instead of the glass substrate (manufactured by Corning Incorporated, Eagle XG) and the heating temperature was 130° C. The obtained thin film was analysed by EPMA and it was found that the thin film contained Zn, Mg and Al at the molar ratios which were almost the same as those in composition E (Zn:Mg:Al=72:24:4 (molar ratio)). Further, the same procedures were carried out with a polyethylene terephthalate (PET) film (a square with 60 mm per side (thickness: 75 μm)) as a substrate and the similar results as above were obtained.

### Reference Example 13

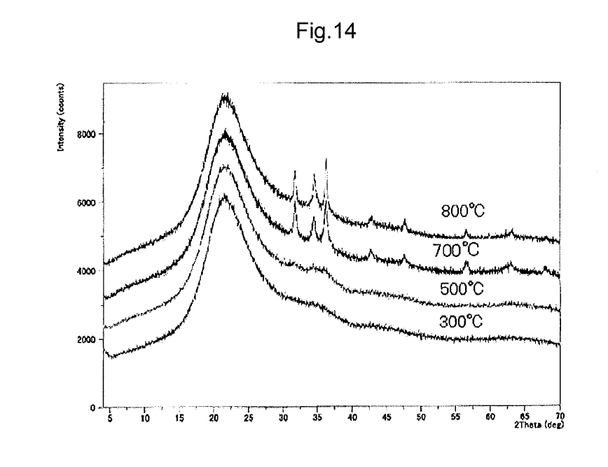

A zinc oxide thin film containing Mg was formed in the same manner as in Example 1 except that a quartz glass substrate instead of the glass substrate (manufactured by Corning Incorporated, Eagle XG) in film formation using composition 5 in Reference Example 8 was heated at 130° C. for 10 minutes followed by heating at 300° C., 500° C., 700° C. and 800° C. for 60 minutes. The obtained thin films were analysed by XRD to obtain the chart shown in FIG. 14. It was found that according to the present method of film formation using the present composition, a thin film in which crystallization was advanced was obtained at or above 500° C.

### Comparative Example 1

To 24.1 g of 2-methoxyethanol were added 1.2 g of zinc acetate dihydrate, 0.3 g of ethanolamine as an auxiliary agent and magnesium trisacetylacetonate at a proportion of a molar ratio Mg/(Mg+Zn) of 0.1 relative to zinc acetate dihydrate and thoroughly stirred to obtain a coating solution containing magnesium. Using the obtained coating solution, film formation was carried out at 200° C. with the same procedures as in Reference Example 1. However, it was not possible to obtain a zinc oxide thin film containing Mg.

### INDUSTRIAL APPLICABILITY

The present invention is useful in the field of production of zinc oxide thin films containing a group 2 element.

### REFERENCE SIGNS LIST

1 Spray bottle
2 Substrate holder (equipped with a heater)
3 Spray nozzle
4 Compressor
5 Substrate
6 Water vapour introducing tube

1. A composition for producing a zinc oxide thin film comprising a group 2 element characterised in that the composition is a solution containing a partial hydrolysate of an organic zinc compound represented by the following general formula (1) and the group 2 element dissolved in an organic solvent (wherein, the solution may further contain a group 13 element):
(Organic zinc compound)
R¹—Zn—R¹ (1)
(wherein R¹ is a C₁₋₇ linear or branched alkyl group).

2. The composition for producing the zinc oxide thin film according to claim 1, wherein the group 2 element is contained as at least one compound selected from the group consisting of
a group 2 element organic compound A represented by the following general formula (2), Z
a hydrolysate obtained by at least partially hydrolysing the group 2 element organic compound A,
a group 2 element organic compound B represented by the following general formula (3), a hydrolysate obtained by at least partially hydrolysing the group 2 element organic compound B, and
a group 2 element inorganic compound represented by the following general formula (4):
(Group 2 element organic compound A)
R²-M-R².(L)n (2)
(wherein M is the group 2 element; R² is independently hydrogen, a C₁₋₈ linear or branched alkyl group, a C₁₋₇ linear or branched alkoxyl group, an acyloxy group or an acetylacetonate group; L is a nitrogen-, oxygen- or phosphorus-containing coordinating organic compound; and n is an integer of 0 to 9);
(Group 2 element organic compound B)
R³-M-X.(L)n (3)
(wherein M is the group 2 element; R³ is a C₁₋₈ linear or branched alkyl group; X is a halogen atom; L is a nitrogen-, oxygen- or phosphorus-containing coordinating organic compound; and n is an integer of 0 to 9);
(Group 2 element inorganic compound)
M_{c}Y_{d}.aH₂O (4)
(wherein M is the group 2 element; Y is hydrogen, a halogen atom, a nitrate group (NO₃⁻) or a sulphate group (SO₄²⁻); when Y is hydrogen, a halogen atom or a nitrate group, c is 1 and d is 2; when Y is a sulphate group, c is 1 and d is 1; and a is an integer of 0 to 9).

3. The composition for producing the zinc oxide thin film according to claim 1, wherein the group 13 element is contained as at least one compound selected from the group consisting of a group 13 element organic compound represented by the following general formula (5), a hydrolysate obtained by at least partially hydrolysing the group 13 element organic compound and a group 13 element inorganic compound represented by the following general formula (6): 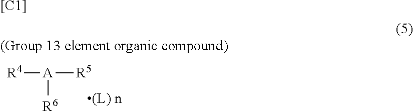
(wherein A is the group 13 element; R⁴, R⁵ and R⁶ are independently hydrogen, a C₁₋₈ linear or branched alkyl group, a C₁₋₇ linear or branched alkoxyl group, an acyloxy group or an acetylacetonate group; L is a nitrogen-, oxygen- or phosphorus-containing coordinating organic compound; and n is an integer of 0 to 9);
(Group 13 element inorganic compound)
AₑZ_{f}.aH₂O (6)
(wherein A is the group 13 element; Z is a halogen atom, a nitrate group (NO₃⁻) or a sulphate group (SO₄²⁻); when Z is a halogen atom or a nitrate group, e is 1 and f is 3; when Z is a sulphate group, e is 2 and f is 3; and a is an integer of 0 to 9).

4. The composition for producing the zinc oxide thin film according to claim 1, wherein:
the partial hydrolysate of the organic zinc compound represented by the general formula (1),
the hydrolysate obtained by at least partially hydrolysing the group 2 element organic compound A represented by the general formula (2),
the hydrolysate obtained by at least partially hydrolysing the group 2 element organic compound B represented by the general formula (3), and
the hydrolysate obtained by at least partially hydrolysing the group 13 element organic compound represented by the general formula (5) are
products obtained by partially or at least partially hydrolysing the compounds with water in a range of a molar ratio of equal to or more than 0.05 to equal to or less than 0.8 relative to the respective compounds, or at least partly or entirely are products obtained by partially or at least partially hydrolysing the respective compounds with water in a range of a molar ratio of equal to or more than 0.05 to equal to or less than 0.8 relative to the total number of moles of the compounds.

5. The composition for producing the zinc oxide thin film according to claim 2, wherein the total number of moles of the group 2 element organic compound A, the group 2 element organic compound B and the group 2 element inorganic compound (including the hydrolysates) is in the proportion of 0.001 to 4 relative to the number of moles of the organic zinc compound (including the partial hydrolysate).

6. The composition for producing the zinc oxide thin film according to claim 1, comprising zinc, the group 2 element and the group 13 element.

7. The composition for producing the zinc oxide thin film according to claim 6, wherein the total number of moles of the group 13 element organic compound and the group 13 element inorganic compound (including the hydrolysate) is in the proportion of 0.000001 to 0.5 relative to the number of moles of the organic zinc compound (including the partial hydrolysate).

8. The composition according to claim 2, wherein the total concentration of the partial hydrolysate of the organic zinc compound, the hydrolysate obtained by at least partially hydrolysing the group 2 element organic compound A, the hydrolysate obtained by at least partially hydrolysing the group 2 element organic compound B and the hydrolysate obtained by at least partially hydrolysing the group 13 element organic compound is in the range of 0.1 mass % to 30 mass % .

9. The composition according to claim 1, wherein the organic zinc compound is a compound wherein le is a C₁₋₆ alkyl group.

10. The composition according to claim 1, wherein the organic zinc compound is diethylzinc.

11. The composition according to claim 1, wherein the group 2 element is at least one selected from the group consisting of Ca, Mg, Ba and Sr.

12. The composition according to claim 11, wherein the group 2 element is Mg.

13. The composition according to claim 2, wherein the group 2 element organic compound A is a compound wherein R² is a C₁₋₈ alkyl group.

14. The composition according to claim 13, wherein the group 2 element organic compound A is ethylbutylmagnesium or dibutylmagnesium.

15. The composition according to claim 1, wherein the group 13 element is at least one selected from the group consisting of B, Al, Ga and In.

16. The composition according to claim 15, wherein the group 13 element organic compound is a compound wherein R⁴, R⁵ and R⁶ are independently a C₁₋₈ alkyl group.

17. The composition according to claim 16, wherein the group 13 element organic compound is trimethylaluminium, triethylaluminium, trimethylgallium, triethylgallium, trimethylindium or triethylindium.

18. The composition for producing the zinc oxide thin film according to claim 1, wherein the organic solvent is an electron donating organic solvent and/or a hydrocarbon compound.

19. A method for producing the composition for producing a zinc oxide thin film comprising a group 2 element according to claim 2, comprising a solution containing a partial hydrolysate of the organic zinc compound represented by the general formula (1) and a group 2 element dissolved in an organic solvent (wherein the solution may further contain a group 13 element), the method comprising any of following steps [1] to [6]:
step [1]: a step of adding water to an organic solvent containing the organic zinc compound represented by the general formula (1) and a group 2 element organic compound A represented by the general formula (2) to partially hydrolyse the organic zinc compound and at least partially hydrolyse the group 2 element organic compound A, thereby obtaining a composition containing hydrolysates (including partial hydrolysates) dissolved in the organic solvent (wherein the amount of water added may be in a range of a molar ratio of equal to or more than 0.05 to equal to or less than 0.8 relative to the total number of moles of the compounds);
step [2]: a step of independently or altogether mixing an organic solvent containing the organic zinc compound represented by the general formula (1), an organic solvent containing the group 2 element organic compound A represented by the general formula (2) and a group 13 element organic compound represented by the general formula (5) and water to partially hydrolyse the organic zinc compound and at least partially hydrolyse the group 2 element organic compound A and the group 13 element organic compound, thereby obtaining a composition containing hydrolysates (including partial hydrolysates) dissolved in the organic solvent (wherein the amount of water added may be in a range of a molar ratio of equal to or more than 0.05 to equal to or less than 0.8 relative to the total number of moles of the compounds);
step [3]: a step of adding, to an organic solvent containing the organic zinc compound represented by the general formula (1), an organic solvent containing at least one compound selected from the group consisting of the group 2 element organic compound A represented by the general formula (2), the group 2 element organic compound B represented by the general formula (3) and a group 2 element inorganic compound represented by the general formula (4) and water independently or altogether to partially hydrolyse the organic zinc compound and at least partially hydrolyse the group 2 element organic compound A and the group 2 element organic compound B, thereby obtaining a composition containing hydrolysates (including partial hydrolysates) dissolved in the organic solvent (wherein the amount of water added may be in a range of a molar ratio of equal to or more than 0.05 to equal to or less than 0.8 relative to the total number of moles of the compounds (wherein the group 2 element inorganic compound represented by the general formula (4) is excluded));
step [4]: a step of mixing an organic solvent containing the organic zinc compound represented by the general formula (1) with an organic solvent containing at least one compound selected from the group consisting of the group 2 element organic compound A represented by the general formula (2), the group 2 element organic compound B represented by the general formula (3) and the group 2 element inorganic compound represented by the general formula (4), an organic solvent containing at least one compound selected from the group consisting of the group 13 element organic compound represented by the general formula (5) and a group 13 element inorganic compound represented by the general formula (6) and water independently or altogether to partially hydrolyse the organic zinc compound and at least partially hydrolyse the group 2 element organic compound A, the group 2 element organic compound B and the group 13 element organic compound, thereby obtaining a composition containing hydrolysates (including partial hydrolysates) dissolved in the organic solvent (wherein the amount of water added may be in a range of a molar ratio of equal to or more than 0.05 to equal to or less than 0.8 relative to the total number of moles of the compounds (wherein the group 2 element inorganic compound represented by the general formula (4) and the group 13 element inorganic compound represented by the general formula (6) are excluded));
step [5]: a step of adding water to an organic solvent containing the organic zinc compound represented by the general formula (1) to obtain a partial hydrolysate of the organic zinc compound (wherein the amount of water added may be in a range of a molar ratio of 0.05 to equal to or less than 0.8 relative to the organic zinc compound) and then adding, to the obtained organic solvent containing the partial hydrolysate of the organic zinc compound, an organic solvent containing at least one compound selected from the group consisting of the group 2 element organic compound A represented by the general formula (2), the group 2 element organic compound B represented by the general formula (3), the group 2 element inorganic compound represented by the general formula (4), a hydrolysate obtained by at least partially hydrolysing the group 2 element organic compound A and a hydrolysate obtained by at least partially hydrolysing the group 2 element organic compound B to obtain a composition (wherein the amount of water added for at least partially hydrolysing each of the group 2 element organic compound A and the group 2 element organic compound B may be in a range of a molar ratio of equal to or more than 0.05 to equal to or less than 0.8, and when a mixture of the group 2 element organic compound A and the group 2 element organic compound B is hydrolysed, the amount of water added may be in a range of a molar ratio of equal to or more than 0.05 to equal to or less than 0.8 relative to the total number of moles of the compounds);
step [6]: a step of adding water to an organic solvent containing the organic zinc compound represented by the general formula (1) to obtain a partial hydrolysate of the organic zinc compound (wherein the amount of water added may be in a range of a molar ratio of equal to or more than 0.05 to equal to or less than 0.8 relative to the organic zinc compound) and then adding, to the obtained organic solvent containing the partial hydrolysate of the organic zinc compound, an organic solvent containing at least one compound selected from the group consisting of the group 2 element organic compound A represented by the general formula (2), the group 2 element organic compound B represented by the general formula (3), the group 2 element inorganic compound represented by the general formula (4), a hydrolysate obtained by at least partially hydrolysing the group 2 element organic compound A and a hydrolysate obtained by at least partially hydrolysing the group 2 element organic compound B, and at least one compound selected from the group consisting of the group 13 element organic compound represented by the general formula (5), a hydrolysate obtained by at least partially hydrolysing the group 13 element organic compound and the group 13 element inorganic compound represented by the general formula (6) to obtain a composition (wherein the amount of water added for at least partially hydrolysing each of the group 2 element organic compound A, the group 2 element organic compound B and the group 13 element organic compound may be in a range of a molar ratio of equal to or more than 0.05 to equal to or less than 0.8, and when a mixture of the group 2 element organic compound A, the group 2 element organic compound B and the group 13 element organic compound is hydrolysed, the amount of water added may be in a range of a molar ratio of equal to or more than 0.05 to equal to or less than 0.8 relative to the total number of moles of the compounds).

20. The method according to claim 19, wherein in the step [2] or [3], water is added in a range of a molar ratio of equal to or more than 0.05 to equal to or less than 0.8 relative to the total number of moles of the organic zinc compound represented by the general formula (1), the group 2 element organic compound A represented by the general formula (2) and the group 2 element organic compound B represented by the general formula (3) to partially hydrolyse the organic zinc compound and at least partially hydrolyse the group 2 element organic compound A and the group 2 element organic compound B.

21. The method according to claim 19, wherein in the step [4], water is added in the range of a molar ratio of equal to or more than 0.05 to equal to or less than 0.8 relative to the total number of moles of the organic zinc compound represented by the general formula (1), the group 2 element organic compound A represented by the general formula (2), the group 2 element organic compound B represented by the general formula (3) and the group 13 element organic compound represented by the general formula (5) to partially hydrolyse the organic zinc compound and at least partially hydrolyse the group 2 element organic compound A, the group 2 element organic compound B and the group 13 element organic compound.
